(19) United States
(12) Patent Application Publication
(10) Pub. No.: US 2010/0246715 A1
(43) Pub. Date: Sep. 30, 2010

(54) WIRELESS COMMUNICATION METHOD AND APPARATUS

(75) Inventors: Ngoc-Dung DAO, Bristol (GB); Yong Sun, Bristol (GB)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/724,814

(22) Filed: Mar. 16, 2010

(30) Foreign Application Priority Data
Mar. 31, 2009 (GB) 0905587.2

(51) Int. Cl. H04L 27/00

(52) U.S. Cl. 375/296

(57) ABSTRACT

In a wireless communications system, a method of processing data prior to transmission thereof to a plurality of stations. The method includes determining a channel matrix using a plurality of weighted channel responses, each of which is associated with one of the plurality of stations and weighted by a gain factor corresponding to the station, wherein the gain factor is inversely proportional to a noise power of the station. The data is then processed in accordance with a precoding scheme using the determined channel matrix.

### FIELD OF THE INVENTION

The present invention relates to wireless communication. It is particularly, but not exclusively, concerned with a method and apparatus for multi-user non-linear precoding in a wireless network.

### BACKGROUND OF THE INVENTION

Multi-user precoding exploits channel information available at a transmitter to facilitate the simultaneous transmission of multiplexed data streams to multiple users. When channel state information (CSI) is available, linear and non-linear precoding can be employed, with non-linear techniques such as Tomlinson-Harashima precoding generally achieving improved performance but at the expense of increased complexity. In practice, only a limited number of users can be accommodated at any given time, and so some method of scheduling users is often implemented jointly with multi-user precoding.

### User Scheduling

Many current and proposed wireless communications systems employ orthogonal frequency division multiple access (OFDMA) modulation. In such systems, a resource block (RB), which can broadly be defined as a unit of radio resource for data transmission, comprises several adjacent subcarriers and several consecutive OFDM symbols. The data stream for a user (or data streams for multiple users, in the case of multi-user precoding) can be sent over one or several RBs.

For example, in the proposed IEEE 802.16m standard (http://wirelessman.org/tgm/), a resource block (also known as a sub-band) is defined as consecutive OFDMA symbols in the time domain, and consecutive subcarriers in the frequency domain.

FIGS. 1a to 1c illustrate three exemplary ways in which users can be assigned to OFDM RBs. In FIG. 1a, several users are allocated to one RB (RB1); in FIG. 1b, several users are allocated to two RBs (RB1, RB5) that are consecutive in time; and in FIG. 1c, users are allocated to two RBs (RB1, RB2) that are along in frequency. The main difference between the allocation of users according to FIGS. 1b and 1c is that, in the case of FIG. 1b, the channels of the two RBs can be considered to be constant, whereas in the case of FIG. 1c, the channels of the two adjacent RBs are different.

The three cases shown in FIG. 1 form the basis from which other combinations of user assignments can be derived and which will be readily apparent to the skilled person.

Known criteria for user selection include:
minimizing the sum of mean square error (MSE) of all users (Kusume, K. et al., “Cholesky Factorization With Symmetric Permutation Applied to Detecting and Precoding Spatially Multiplexed Data Streams”, IEEE Transactions on Signal Processing, vol. 55, no. 6, pp. 3089-3103, June 2007; and Schmidt, D. A. et al., “Minimum mean square error vector precoding”, Proc. IEEE Conf. on Personal, Indoor, and Mobile Radio Communications, vol. 1, Berlin, Germany, September 2005, pp. 107-111);
maximizing the orthogonality among users in one RB (Yoo, T. and Goldsmith, A. “On the optimality of multiantenna broadcast scheduling using zero-forcing beamforming”, IEEE Journal on Selected Areas in Communications, vol. 24,. No. 3, pp. 528-541, March 2006); and
maximizing the upper bound on capacity of the multi-user precoding (Zhang, X. and Lee, J. “Low complexity MIMO scheduling with channel decomposition using capacity upperbound”, IEEE Transactions on Communications, vol. 56, no. 6, pp. 871-876, June 2008).

### Linear Precoding

In linear precoding, a linear transformation is applied to a data stream prior to its transmission. Exemplary linear precoding approaches are described in Joham, M. et al., “Linear transmit processing in MIMO communications systems”, IEEE Transactions on Signal Processing, vol. 53, no. 8, pp. 2700-2712, August 2005; and Peel, C. B. et al., “A vector-perturbation technique for near-capacity multiantenna multiuser communication-part I: channel inversion and regularization”, IEEE Transactions on Communications, vol. 53, no. 1, pp. 195-202, January 2005.

A general block diagram of a communications system 200 implementing linear, multi-user precoding is depicted in FIG. 2. At a transmitter 202, a power loading unit 206 allocates different transmit power to data streams by multiplying the users' data vectors with a diagonal matrix Λ. For convenience, it is often assumed that a uniform power allocation among users is employed, in which case the diagonal matrix Λ is identity (Λ=I). A precoding unit 208 generates a precoding matrix P to precode the data vector s, resulting in the precoded data vector x, which is then transmitted across a channel H. At a receiver 204, a receiver filter 210 may be used to improve the performance. Then a detector 212 detects the signals output by of the receiver filter to provide an estimated data vector sₑₛₜ.

If it is assumed that the channel H exhibits frequency flat fading, the fading model may be directly extended to one RB of OFDMA systems. In one RB, the subcarrier channels are highly correlated. Thus channel vectors of one representative subcarrier can be used for user selection. Let the number of selected users be K≦M, where M is the number of antennas at the transmitter. Each user has single receive antenna and the receiver filter, which here is defined as a variable scalar gₖ(k=1, 2, . . . , K). Let G=diag(g₁, g₂, . . . g_{K}) and H=[h₁^{T} h₂^{T} . . . h_{K}^{T}]^{T} be the channel matrix, obtained by stacking the row channel vector hₖ of user k(k=1, . . . , K), where superscript T denotes matrix transpose operation.

In the block diagram of linearly precoded system in FIG. 2, the transmit signal is precoded by a matrix P as

x=Ps, (1)

and the received signals of all users after the receiver filter module is

z=G(Hx+n)=G(HPs+n). (2)

A brief overview of how precoding matrices and their mean square error (MSE) are generated is now presented, for both minimum mean square error (MMSE) and zero forcing (ZF) precoders. Subsequently, the discussion will focus on MMSE precoders, which can be considered a more generalized precoder than ZF precoders.

For the linear MMSE precoder (or Wiener filter precoding) proposed in Joham et al. (2004) and Peel et al. (2005), the precoding matrix is given as

$$P = {β ( {H}^{H} {G}^{H} GH + \frac{tr ( {GR}_{n} {G}^{H} )}{{E}_{tr}} {I}_{M} )}^{- 1} {H}^{H} G \qquad ( 3 )$$

where Rₙ is the noise covariance matrix, Eₜᵣ is the total transmit power, I_{M} is an M×M identity matrix, and superscript H denotes matrix transpose conjugate operation.

Let

$$F = {H}^{H} {G}^{H} GH + \frac{tr ( {GR}_{n} {G}^{H} )}{{E}_{tr}} {I}_{M} . \qquad ( 4 )$$

The power normalization scalar β is given as

$$β = \sqrt{\frac{{E}_{tr}}{tr ( {F}^{- 2} {H}^{H} {G}^{H} {R}_{s} GH )}} . \qquad ( 5 )$$

The sum MSE for the linear MMSE precoder follows

$$ψ = tr ( {( \frac{{E}_{tr}}{tr ( {GR}_{n} {G}^{H} )} {GHH}^{H} {G}^{H} + {I}_{K} )}^{- 1} {R}_{s} ) . \qquad ( 6 )$$

Note that Rₛ is the signal covariance matrix, which is equal to the power loading matrix Λ, and I_{K} is a K×K identity matrix. Here, set Rₛ=I_{K}, since no power loading is considered for this particular case.

For the linear zero forcing (ZF) precoder, the precoding matrix can be obtained by removing the term

$$\frac{tr ( {GR}_{n} {G}^{H} )}{{E}_{tr}} {I}_{M}$$

in equations (3) and (4). The sum MSE for the ZF precoder is obtained by removing the identity matrix I_{K} in equation (6).

From the optimization of the linear MMSE precoder, the cost metric is the sum MSE of users given in equation (6). First, the situation schematically depicted in FIG. 1a (one RB) is considered. The target is to select K out of K_{T} users such that the selected users have the smallest sum MSE.

In equation (6), the optimal solution could be obtained by performing an exhaustive search for a combination of user that minimize the sum MSE metric ψ,

$$ψ = tr [ {( \frac{{E}_{tr}}{tr ( {GR}_{n} {G}^{H} )} {GHH}^{H} {G}^{H} + {I}_{K} )}^{- 1} ] . \qquad ( 7 )$$

Such an exhaustive search may be too complex computationally as the number of user combinations is

$$( \begin{matrix}K \\ {K}_{T}\end{matrix} ) = \frac{{K}_{T} !}{K ! ( {K}_{T} - K ) !} . \qquad ( 8 )$$

In Karaa, H. and Adve, R. S, “User Assignment for MIMO-OFDM Systems with Multiuser Linear Precoding”, IEEE Wireless Communications and Networking Conference 2008, WCNC 2008, pp. 952-957, a user selection algorithm applying the virtual uplink concept is suggested. A power allocation scheme is proposed for a virtual uplink. The users having minimal virtual uplink MSE will be selected. However, this approach requires optimization tools having high complexity.

For the situations schematically depicted in FIGS. 1b and 1c, in which users are assigned to two different RBs, exhaustive user selection is similarly highly complex. Currently, low-complexity solutions have not been proposed.

### Non-Linear Precoding

Fundamentally, non-linear precoding is based on the concept of Dirty Paper Coding (DPC), the basic premise of which is to pre-subtract known interference at the transmitter such that the capacity is effectively the same as if there was no interference at all.

Exemplary non-linear precoding approaches are described in Hochwald, B. M. et al., “A vector-perturbation technique for near-capacity multiantenna multiuser communication-part IL perturbation”, IEEE Transactions on Communications, vol. 53, no. 3, pp. 537-544, March 2005); Kusume et al. (2007); and Schmidt et al. (2005).

For non-linear precoding approaches the communications system of FIG. 2 can be modified by the addition of a vector perturbation unit 314 at the transmitter 302, as shown in FIG. 3. Also at the transmitter side, power loading can applied to the users' data streams by a power loading unit 306, though for this discussion it is again assumed that no power loading is employed. This means that the power loading matrix Λ is identity. Then the perturbation unit 314 adds a perturbation (translation) vector to a user's data vector, so as to minimize a performance metric, for example the instantaneous transmit energy (the transmit power for each channel use) or the sum MSE of all users. Finally, in precoding unit 308, a precoding matrix P is applied to the perturbed data vector.

At the receiver 304, a receiver filter 310 is used to provide more freedom in optimizing the receiver performance. Then the perturbation data is removed by unit 316 and unperturbed received signals are used to detect the transmitted data by detector 312.

### Tomlinson-Harashima Precoding

Of the known non-linear precoding techniques, Tomlinson-Harashima (TH) precoding provides an efficient yet simple solution which nearly approaches the capacity of the broadcast channels. In TH precoding the feedback part of decision feedback equalization (DFE) is performed at the transmitter.

Exemplary TH precoding techniques are described in Joham, M. et al. “MMSE approaches to multiuser spatio-temporal Tomlinson-Harashima precoding”, Proc. 5^{th} ITG Conf Source and Channel Coding Erlangen, Germany, January 2004, p. 387; Windpassinger, C. et al. “Precoding in multiantenna and multiuser communications”, IEEE Transactions on Communications, vol. 3, no. 4, pp. 1305-1316, 2004; and Liu, J. and Kizymien, W. A., “Improved Tomlinson-Harashima precoding for the downlink of multi-user MIMO systems”, Canadian Journal of Electrical and Computer Engineering, vol. 32, no. 3, pp. 133-144, Summer 2007.

Further, the method proposed in Kusume et al. (2007) and EP1782554 (Precoder and method for precoding an input sequence to obtain a transmit sequence) provides good performance in terms of bit error rate (BER) and its performance is close to the vector perturbation (VP) precoding of Schmidt et al. (2005).

FIG. 4 shows a block diagram of a system 400 using non-linear TH precoding. At the transmitter 402, data vector s is permuted by a matrix II 406. Then the feedback precoding matrix B-I 408 in combination with Mod module 410 is to sequentially compute the perturbation data of users. The feedforward precoding matrix F 412 precode the perturbed data vector. For simplicity, it is assumed that each user has single receive antenna. Hence, the receiver filter is omitted.

It is also assumed that the transmitter knows the channels of all of the users. Let hₖ=[h₁ h₂ . . . h_{M}] be the channel vector from the transmitter to a user k. Stacking all the users' channel vectors, a channel matrix of all users is obtained as

H=[h₁^{T} h₂^{T} . . . h_{K}^{T}]^{T}. (9)

At the transmitter side, data symbols of users are first permuted and then processed in two steps: backward precoding and feedforward precoding. The permutation matrix Π plays an important role in improving the average bit error rate (BER) performance of all users. In the feedback and feedforward precoding matrices, B and F, are specified as follows.

Let

$$Φ = {HH}^{H} + \frac{tr ( {R}_{n} )}{{E}_{tr}} {I}_{K} , \qquad ( 10 )$$

and

ΠΦ⁻¹Π^{T}=U^{H}DU (11)

where is the noise covariance matrix of users and Eₜᵣ, is the total transmit power. The matrices Π, U and D are jointly computed by a Cholesky factorization with symmetric permutation in Kusume et al. (2007); and Golub, G. H. and Loan, C. F. V. “Matrix Computations”, 3^{rd} ed. Baltimore, Md.: Johns Hopkins Univ. Press, 1996. The matrix U is an upper triangular with ones in the main diagonal, while D is a diagonal matrix. In Kusume et al. (2007), the factorization in equation (11) produces a lower triangular matrix. This difference just changes the precoding order of users but has no impact on the average BER of all users.

It will be appreciated that the noise of a user receiver includes thermal noise of receiver itself and interference noise from the wireless channel.

The feedback precoding matrix B and feedforward precoding matrix F are specified as follows.

B=U⁻¹, (12)

F=β F̅ (13)

where

$$\begin{matrix}\overline{F} = {H}^{H} {Π}^{T} {U}^{H} D , & ( 14 ) \\ χ = {( {‖ \overline{F} ( : , 1 ) ‖}_{F}^{2} + ɛ {‖ \overline{F} ( : , 2 : K ) ‖}_{F}^{2} )}^{- 1} , & ( 15 ) \\ β = \sqrt{\frac{{E}_{s}}{χ}} , & ( 16 ) \\ ɛ = \frac{μ}{μ - 1} , & ( 17 )\end{matrix}$$

and μ is the size of the QAM constellation. The factor ε is known as precoding loss of TH precoding in literature.

It can be shown that the sum of mean-square-error (MSE) of all users due to the above TH precoder is

$$ψ = β ( {d}_{k} + {\sum }_{k = 1}^{K - I} ɛ {d}_{k} ) \qquad ( 18 )$$

where dₖ is the k-th diagonal entry of matrix D.

For a given channel H, user ordering for precoding greatly affects the overall performance of TH precoding. Therefore, finding the optimal user permutation matrix Π is crucial for minimizing the MSE metric of equation (18). The optimal permutation can be obtained by an exhaustive search of all possible user permutations. The best permutation is the one that gives the smallest sum MSE. However, the number of permutations, which is K!, can be very large when a large number of users are present. Such an approach could therefore be too complex to implement.

A method to compute Π is proposed in Kusume et al. (2007), which is shown to be near optimal in the sense that the SNR loss is negligible. In that proposed method, the matrices Π, U and D are jointly optimized based on a Cholesky factorization with symmetric permutation, as per Windpassinger et al. (2004). The algorithm selects one user in each step of Cholesky factorization such that the best user (with smallest MSE among the remaining unsorted users) is selected. In this way, the best user is selected first but it is precoded last, i.e. the precoding order of permuted users 1 to K will be K to 1. This principle is regarded as best-last precoding strategy. On the other hand, the worst user (with largest MSE) is selected last and hence precoded first. This approach provides more protection for the worst user, such that the BER of the worst user will be improved. In this way, the average BER of all users is reduced.

Tomlinson-Harashima Precoding with Power Allocation

In practice, users may have different channel and noise power, which is not taken into account by the MMSE based TH precoding described above. Instead, the sum of the noise power is used in the precoding matrices (c.f. equation (10), through the trace operator) and, by extension, in the MSE metric of equation (18). Therefore, it is possible that the user with the largest noise power will not be suitably protected. Therefore, the average BER of all users may actually increase notably.

By way of example, consider a system where the transmitter has 4 transmit antennas, and 4 single-receive antenna users. The channel power of users have different values, which means the variance σₖ² the rows k (k=1, 2, 3, 4) of H are different. Assume the values of σₖ² are [σ₁² σ₂² σ₃²σ₄²]=[1 4 1 1]. The noise powers vₖ², of users are [v₁² v₂² v₃² v₄²]=[1 8 1 1].

In FIG. 5, the BER of these users are plotted. Since user 2 has strong noise power and low signal power, its performance is the worst amongst the users. In this example, user 2 has the strongest channel power, but it also has strongest noise power. Hence user 2 may need more protection than the other users by being precoded first (or selected last). However, since its channel has the strongest power, it is likely that user 2 will be selected first and precoded last.

This prediction is supported by simulations of the probability of precoding order of users, shown in FIG. 6 for a total transmit power of 20 dB. The probability of user 2 being precoded first is 0.83%, whereas the probability of user 2 being precoded last is 80.6%. Meanwhile, the probability of user 1 being precoded first is 33.4%, whereas the probability of user 1 being precoded last is 6.36%.

Therefore, the BER of user 2 is high compared to the BER of the other users, as shown in FIG. 5. The SNR gap of user 2 is about 8 dB compared with the other users at BER of 10⁻². Hence, the MMSE-based TH precoding scheme described above is not optimized for real wireless channels, where users may have different channel and noise powers.

To improve the average BER of all uses, power allocation may be employed. With power loading, the matrix Λ in FIG. 3 is not identity. In Sanguinetti, L. and Morelli, M. “Non-linear Pre-Coding for Multiple-Antenna Multi-User Downlink Transmissions with Different QoS Requirements”, IEEE Transactions on Wireless Communications, vol. 6, no. 3, pp. 852-856, march 2007, a power loading for users has been presented for zero-forcing (ZF) TH precoding. However, this method is not applicable for MMSE-based TH precoding, because changing the power of one user will make unpredictable interferences to the other users. Additionally, once the powers of users are modified, the optimal user-ordering is also changed. Therefore, the optimal power allocation for MMSE-based TH precoding may involve complex iterations of power allocation and optimal user ordering searches. One such method has been suggested in Hunger, R. et al. “Alternating Optimization for MMSE Broadcast Precoding”, 2006 IEEE International Conference on Acoustics, Speech and Signal Processing, vol. 4, no. IV, pp. 14-19, May 2006. Nevertheless, this method implements a high complexity optimization algorithm and does not always improve the worst user BER and the system performance.

Another disadvantage of power loading for MMSE-based precoding is that the optimal receiver filter G will be dependent on power loading matrix Λ. The two matrices G and Λ should be jointly designed. For example, Shi, S. and Boche, H. “Downlink MMSE Transceiver Optimization for Multiuser MIMO Systems: Duality and Sum-MSE Minimization”, IEEE Transactions on Signal Processing, vol. 55, no. 11, pp. 5436-5446, November 2007, presents solutions for linear MMSE precoding, but the joint optimization has high complexity. It is expected that for non-linear MMSE THP precoder, the joint optimization is even more complex. Additionally, once the matrix G is computed, the receiver filter must be sent to user equipment (UE), which consumes the downlink bandwidth and also increases the system complexity.

There is therefore a need for improved methods and apparatus for precoding in wireless communications systems, and particularly methods and apparatus taking stations' noise power into consideration.

### SUMMARY OF THE INVENTION

According to an aspect of the invention there is therefore provided a method of processing data prior to transmission thereof to a plurality of stations in a wireless communications system, the method comprising: determining a channel matrix using a plurality of weighted channel responses, each of which is associated with one of the plurality of stations and weighted by a gain factor corresponding to the station, wherein the gain factor is inversely proportional to a noise power of the station; and processing the data in accordance with a precoding scheme using the channel matrix.

This provides a straightforward way in which to integrate stations' different noise powers during precoding, substantially without necessitating a change to the precoding scheme or to a scheduling scheme (where implemented).

In a preferred embodiment, for example where stations are aware of the particular precoding scheme, the method further comprises receiving feedback information from each of the plurality of stations, wherein the feedback information comprises the weighted channel response. Alternatively, for example for legacy stations, a preferred embodiment further comprises receiving feedback information from each of the stations, wherein the feedback information comprises a channel response and the noise power; calculating the gain factor for each of the noise powers; and weighting each channel response with the corresponding gain factor.

In a preferred embodiment the gain factor is defined using the relation gₖ=aₖvₖ⁻¹, wherein vₖ is the noise power and aₖ is a positive real number. This provides a greater degree of freedom in user ordering.

It is envisaged that the method can be applied to many different kinds of precoding. However, in a preferred embodiment the precoding scheme comprises a minimum mean square error (MMSE) Tomlinson-Harashima (TH) precoding scheme.

Where TH precoding is implemented, a preferred embodiment comprises determining a matrix Φ using the relation

$$Φ = \hat{H} {\hat{H}}^{H} + \frac{K}{{E}_{tr}} {I}_{K} ,$$

wherein Ĥ is a channel matrix determined by the determining, K is the number of stations whose data is to be processed, and Eₜᵣ is the total transmit power.

In a related aspect of the invention there is provided a method of transparently providing a station with a data recovery functionality, the data being subjected to a precoding scheme prior to transmission to the station, the method comprising: transmitting a scalar to the station, the scalar comprising a combination of a power normalization factor and a gain factor, wherein the gain factor is inversely proportional to a noise power of the station.

In a related aspect of the invention there is provided a multiple antenna apparatus for transmitting data to a plurality of stations, the apparatus comprising: means for determining a channel matrix using a plurality of weighted channel responses, each of which is associated with one of a plurality of stations and weighted by a gain factor corresponding to the station; and means for processing the data in accordance with a precoding scheme using the channel matrix.

In a preferred embodiment the multiple antenna apparatus comprises means for calculating the gain factor for each of the noise powers; and means for weighting each channel response with the corresponding gain factor.

In a preferred embodiment of the invention the multiple antenna apparatus comprises means for calculating scalars, each comprising a combination of a power normalization factor and a gain factor corresponding one of the plurality of stations.

In a related aspect of the invention there is provided a method of feeding back information to a multiple antenna apparatus from a station in a wireless communications system, the method comprising: measuring a channel response and a noise power; calculating a gain factor for the noise power, the gain factor being inversely proportional to the noise power; weighting the channel response with the gain factor; and transmitting the weighted channel response to the multiple antenna apparatus. The signal and noise measurements can be processed in baseband.

By combining the noise power and gain factor, signalling overhead can be reduced.

In a related aspect of the invention there is provided a method of recovering received data at a station, the received data having been subjected to a precoding scheme prior to transmission, the precoding scheme using a channel matrix comprising a weighted channel response associated with the station, the weighted channel response being weighted by a gain factor that is inversely proportional to a noise power of the station, the method comprising: applying the gain factor to the received data.

In a preferred embodiment the method comprises applying a scalar comprised of a combination of a power normalization factor and the gain factor.

In a related aspect of the invention there is provided a station for receiving data from a multiple antenna apparatus, the station comprising: means for measuring a noise power; means for measuring a channel response; means for calculating a gain factor for the noise power, the gain factor being inversely proportional to the noise power; means for weighting the channel response with the gain factor; and means for applying the gain factor to the received data.

In a related aspect of the invention there is provided a method of communicating between a multiple antenna apparatus and a plurality of stations, the method comprising: feeding back information from the plurality of stations to the multiple antenna apparatus as described; processing data to be transmitted from the multiple antenna apparatus to the plurality of stations as described; receiving the data at the plurality of stations; and recovering the data in accordance as described.

In a related aspect of the invention there is provided a wireless communication system comprising: a multiple antenna apparatus as described; and a plurality of stations as described.

The invention may also be provided by computer implemented means, such as software configuring a general-purpose communications configured computer apparatus, or more application specific apparatus such as an AIS, an FPGA or a DSP. To this end, the invention may be embodied in a software product, which may be delivered on computer readable storage media, such as optical or magnetic media or flash memory storage media, or by means of a computer receivable signal, such as a downloaded file or collection of files. No part of the following description of specific embodiments of the invention should be interpreted as a limitation on the scope of application of the invention, as the embodiment so described are provided by way of example only, with reference to the accompanying drawings.

### BRIEF DESCRIPTION OF THE DRAWINGS

Embodiments of the present invention will now be described with reference to the accompanying drawings, wherein:

FIGS. 1a to 1c illustrate three exemplary ways in which stations can be assigned to OFDM resource blocks;

FIG. 2 shows a general block diagram of a communications system implementing linear, multi-user precoding;

FIG. 3 shows a general block diagram of a communications system implementing non-linear, multi-user precoding;

FIG. 4 shows a general block diagram of a communications system implementing Tomlinson-Harashima precoding;

FIG. 5 shows simulated results for Tomlinson-Harashima precoding in which stations' noise powers are assumed to be different;

FIG. 6 shows simulated probability mass function results of FIG. 5;

FIGS. 7 to 15 each illustrate a method of scheduling stations according to the present invention;

FIGS. 16 and 17 show simulation results of the performance of the methods for scheduling stations to one resource block according to the present invention;

FIG. 18 shows simulation results of the performance of the methods for scheduling stations to two resource blocks according to the present invention;

FIG. 19 show simulation results of the performance of the methods for scheduling stations to two resource blocks, when applied to nonlinear TH precoding, according to the present invention;

FIG. 20 schematically shows the structure of a station according to the present invention;

FIG. 21 schematically shows a system for implementing scheduling and precoding according to the present invention;

FIG. 22 shows a block diagram of a station for implementing scheduling and precoding according to the present invention;

FIG. 23 schematically shows a system for implementing gain adjusted TH precoding according to the present invention;

FIG. 24 schematically shows the signalling exchanges between a transmitter station and a receiver station implementing gain adjusted TH precoding according to the present invention;

FIGS. 25a to 25c schematically shows the signalling exchanges between a transmitter station and a receiver station for conventional TH precoding, gain adjusted TH precoding according to the present invention in the system of FIG. 23; and gain adjusted TH precoding according to the present invention for legacy receiver stations.

FIG. 26 schematically shows where noise power can be measured in a receiver station according to the present invention;

FIGS. 27 to 31 show simulation results of the performance of the gain adjusted TH precoding method according to the present invention.

### DETAILED DESCRIPTION OF THE DRAWINGS

For convenience, the following description is organized into sections. Initially, a discussion of station scheduling is presented, in particular how to schedule K out of K_{T} stations for one resource block, and how to schedule K_{T} stations for two resource blocks. Station scheduling for more than two resource blocks is also described. Low-complexity selection rules are developed in the context of linear precoding, and exemplary methods of implementation presented. It will become apparent that the developed techniques can also be applied in conjunction with non-linear precoding schemes such as TH precoding. Although at first uniform noise power is assumed, it is subsequently shown how the described techniques can be modified to take account of stations' different noise powers, with particular reference to TH precoding, for which an improved method of station ordering is presented.

Also for convenience, algorithms will be referred to in shorthand, such as “I-A”, “I-B” and so on for station scheduling for one resource block, and “II-A”, “II-B” and so on for station scheduling for two resource blocks.

### Station Scheduling for One Resource Block

Station scheduling for one resource block is described with reference to a communication system in which a transmitter station with M transmit antennas, such as a base station (BS), sends multiple data streams simultaneously to K receiving stations (out of K_{T} total stations). Such a communication model is called a broadcast system. Although it will be appreciated that stations may have several receive antennas, for simplicity it is assumed that each station has a single receive antenna. Exemplary embodiments of the stations will be described in due course.

Where stations are assumed to have the same value of noise power, the noise covariance matrix as well as the receiver filter matrix equal identity, i.e. Rₙ=I and G=I. The MSE metric in equation (7) therefore becomes

$$ψ = {tr ( \frac{{E}_{tr}}{K} {HH}^{H} + {I}_{K} )}^{- 1} . \qquad ( 19 )$$

Equation (19) can be used for exhaustive station searching. As noted earlier, the complexity of such an approach is high where a large number of stations K_{T} is involved.

A more convenient form of equation (19) is derived below, allowing low-complexity station selection algorithms to be obtained.

Assume that k is the number of stations being selected in the determination process. Let H be the channel matrix of these k users. A singular value decomposition of H=UDV is employed, where U and V are unitary matrices and D is a diagonal matrix. Let dᵢ (i=1, 2, . . . , n) be singular values of H. Note that during the determination process, k may be larger or smaller than K If k≦M, then n=k; otherwise n=M. Letting α=K/Eₜᵣ, the sum of MSE metric in equation (19) then becomes

$$\begin{matrix}ψ = {tr ( {α}^{- 1} {HH}^{H} + {I}_{k} )}^{- 1} \\ = {tr ( {α}^{- 1} {UDD}^{H} {U}^{H} + {I}_{k} )}^{- 1} \\ = tr [ {U ( {α}^{- 1} {DD}^{H} + {I}_{k} )}^{- 1} {U}^{H} ] \\ = \{ \begin{matrix}{\sum }_{i = 1}^{k} \frac{1}{{α}^{- 1} {d}_{i}^{2} + 1} & if k \leq M \\ k - M + {\sum }_{i = 1}^{k} \frac{1}{{α}^{- 1} {d}_{i}^{2} + 1} & if k > M\end{matrix}\end{matrix} \qquad ( 20 )$$

(The cyclic property of trace operation, tr(ABC)=tr(CAB), is used to obtain the fourth line of equation (20) above).

Using equation (20) for station selection, the number of stations k selected for access to the resource block can be changed during the determination process. Typically, in order to compute MSE a matrix inversion operation needs to be performed repeatedly.

However, the computational complexity associated with such an operation is prohibitively high. This problem can be avoided by considering another quantity

$$\begin{matrix}ϕ = {tr ( {α}^{- 1} {H}^{H} H + {I}_{M} )}^{- 1} \\ = {tr ( {α}^{- 1} {V}^{H} {D}^{H} DV + {I}_{M} )}^{- 1} \\ = tr [ {{V}^{H} ( {α}^{- 1} {D}^{H} D + {I}_{M} )}^{- 1} V ] \\ = \{ \begin{matrix}M - k + {\sum }_{i = 1}^{k} \frac{1}{{α}^{- 1} {d}_{i}^{2} + 1} if k \leq M \\ {\sum }_{i = 1}^{k} \frac{1}{{α}^{- 1} {d}_{i}^{2} + 1} if k > M\end{matrix} \\ = M - k + ψ .\end{matrix} \qquad ( 21 )$$

Thus, instead of finding a combination of stations minimizing the sum of MSE ψ, the stations that minimize φ can be equivalently found. The format of φ in the first line of equation (21) is mathematically convenient for deriving low-complexity station selection algorithms. The advantage of computing φ is that the size of matrix (α⁻¹H^{H}+I_{M})⁻¹ is M×M, which is independent of the number of stations k being processed.

Let Ω={1, 2, . . . , K_{T}} be the set of indices of all stations, S⊂Q be a subset of Ω containing the indices of any K stations and H̅ₛ be the associated channel matrix of these K stations. Then the subset ω of K stations to be selected can satisfy

$$\begin{matrix}ω = arg {min}_{S} [ {tr ( {α}^{- 1} {\overline{H}}_{s}^{H} {\overline{H}}_{s} + {I}_{M} )}^{- 1} ] \\ arg {min}_{S} [ {tr ( {\overline{H}}_{s}^{H} {\overline{H}}_{s} + α {I}_{M} )}^{- 1} ] .\end{matrix} \qquad ( 22 )$$

The above optimization problem can be solved by an approach that is loosely based on a technique developed in Gorokhov, A. et al. “Receive antenna selection for MIMO spatial multiplexing: theory and algorithms”, IEEE Transactions on Signal Processing, vol. 5, no. 11, pp. 2796-2807, November 2003, namely decremental receive antenna selection (RAS), in which the objective is to select n out of N receive antennas for an MMSE receiver in point-to-point MIMO. The approach of Gorokhov first assumes all receive antennas are selected, and then, one by one, antennas are deselected such that the remaining antennas yield the largest open-loop MIMO capacity.

Although the approach described here is similar to the decremental receive antenna selection technique described in Gorokhov (2003), in the sense that stations are removed one at a time, it will be appreciated that there is a fundamental difference between the problem of user selection in multi-user MIMO (MU-MIMO) and receive antenna selection (RAS) in single user MIMO (SU-MIMO). In particular, in SU-MIMO, the number of selected receive antennas n should not be less than the number of transmit antennas. By contrast, the number of selected stations K in MU-MIMO cannot be larger than the number of transmit antennas. However, the decremental search process is still mathematically correct and its performance is in fact nearly optimal.

Let H be the channel matrix of all users. If hᵢ is the channel vector of the removed station i, the channel matrix of the remaining stations (i.e. without station i) is H_{K}_{_{T}}₋₁. Thus

H_{K}_{_{T}}₋₁^{H}H_{K}_{_{T}}₋₁=H^{H}H−hᵢ^{H}hᵢ. (23)

Making use of the matrix inversion lemma, where A is a n×n positive definite matrix and a is a n×1 vector, then

(A−aa^{H})⁻¹=A⁻¹+a(1−a^{H}A⁻¹a)⁻¹a^{H}A⁻¹. (24)

By replacing A=H^{H}H+αI_{M} and a=hᵢ^{H}, the following relationship is obtained

(H_{K}_{_{T}}₋₁^{H}H_{K}_{_{T}}₋₁+αI_{M})⁻¹=A⁻¹+A⁻¹hᵢ^{H}(1−hᵢA⁻¹hᵢ^{H})⁻¹hᵢA⁻¹. (25)

Hence, once A⁻¹ has been computed, the left hand side of equation (25) can be found without matrix inversion. Since A is positive definite, A⁻¹ is also positive definite. Let

hᵢA⁻¹=gᵢ, (26)

which can be simplified as

(H_{K}_{_{T}}₋₁^{H}H_{K}_{_{T}}₋₁+αI_{M})⁻¹=A⁻¹+(1−gᵢhᵢ^{H})⁻¹gᵢ^{H}gᵢ. (27)

Consequently,

$$\begin{matrix}{tr ( {H}_{{K}_{T} - 1}^{H} {H}_{{K}_{T} - 1} + α {I}_{M} )}^{- 1} = tr ( {A}^{- 1} ) + tr [ \frac{{g}_{i}^{H} {g}_{i}}{1 - {g}_{i} {h}_{i}^{H}} ] \\ = tr ( {A}^{- 1} ) + \frac{{‖ {g}_{i} ‖}^{2}}{1 - {g}_{i} {h}_{i}^{H}}\end{matrix} \qquad ( 28 )$$

where ∥gᵢ∥ denotes the norm of vector gᵢ. Thus, one station can be removed such the left hand side of equation (28) is minimized, which means that the removed station j follow;

$$j = arg {min}_{i ∈ Ω} \frac{{‖ {g}_{i} ‖}^{2}}{1 - {g}_{i} {h}_{i}^{H}} . \qquad ( 29 )$$

After the first station is removed, further stations can be removed until there are only K stations left. In each step, the matrix A⁻¹ can be updated as A⁻¹←A⁻¹+(1−gᵢhᵢ^{H})⁻¹gᵢ^{H}gᵢ.

This results in a decremental station selection method, which is summarized below in pseudo code form.

“Algorithm I-A”

| | |
|---|---|
| (1) | Initialization: input H, α, K, Ω = {1, 2, . . . , K_{T}} |
| (2) | compute A⁻¹ = (H^{H}H + αI_{M})⁻¹ |
| (3) | for l = 1 : K_{T} − K |

| | |
|---|---|
| (4) | compute gᵢ = hᵢA⁻¹ for all i ∈ Ω |
| (5) | $j = arg {min}_{i ∈ Ω} [ {( 1 - {g}_{i} {h}_{i}^{H} )}^{- 1} {‖ {g}_{i} ‖}^{2} ]$ |
| (6) | update A⁻¹ ← A⁻¹ + (1 − gⱼjⱼ^{H})⁻¹ gⱼ^{H}gⱼ |
| (7) | Ω = Ω \ j |

| | |
|---|---|
| (8) | end |
| (9) | Output selected station indices ω = Ω |

Alternatively, a subset of stations initially comprising just one station can be determined, to which stations can be added one at a time. This approach will be referred to as incremental station selection. It is noted in Gorokhov (2003) that incremental antenna selection is not suitable for the MMSE receiver as the number of receive antennas must be at least the same as the number of the transmit antennas to achieve a good performance for the single-station point-to-point MIMO transmission. In contrast to the point-to-point MIMO transmission, the number of users in multiuser point-to-multipoint MIMO is not greater than the number of transmit antennas.

Again, the matrix inversion lemma can be applied for incremental station selection. The only change in equation (24) is the reverse of addition and minus operators, so that

(A+aa^{H})⁻¹=A⁻¹−A⁻¹a(1+a^{H}A⁻¹a)⁻¹a^{H}A⁻¹. (30)

Let A=αI_{M}, a=hᵢ^{H}, Ω={1, 2, . . . , K_{T}}, gᵢ=hᵢA⁻¹, so that the first station can be selected such that

$$\begin{matrix}j = arg {max}_{i ∈ Ω} \frac{{‖ {g}_{i} ‖}^{2}}{( 1 + {g}_{i} {h}_{i}^{H} )} \\ = arg {max}_{i ∈ Ω} \frac{{‖ {h}_{i} ‖}^{2}}{{α}^{2} + α {‖ {h}_{i} ‖}^{2}} \\ = arg {max}_{i ∈ Ω} {‖ {h}_{i} ‖}^{2} .\end{matrix} \qquad ( 31 )$$

Then the matrix A⁻¹ is updated as A⁻¹←A⁻¹−(1+gⱼhⱼ^{H})⁻¹gⱼ^{H}gⱼ. The second station can be selected similarly. A pseudo code description of this incremental station selection algorithm is detailed below.

“Algorithm I-B”

| | |
|---|---|
| (1) | Initialization: input H, α, K, Ω = {1, 2, . . . , K_{T}}, ω = Ø |
| (2) | compute A⁻¹ = α⁻¹I_{M} |
| (3) | $j = arg {max}_{i ∈ Ω} {‖ {h}_{i} ‖}^{2}$ |
| (4) | ω = ω ∪ j, Ω = Ω \ j, gⱼ = hⱼA⁻¹ |
| (5) | for l = 1 : K − 1 |

| | |
|---|---|
| (6) | update A⁻¹ ← A⁻¹ − gⱼ^{H} (1 + gⱼhⱼ^{H})⁻¹ gⱼ |
| (7) | compute gᵢ = hᵢA⁻¹ for all i ∈ Ω |
| (8) | $j = arg {max}_{i ∈ Ω} \frac{{‖ {g}_{i} ‖}^{2}}{( 1 + {g}_{i} {h}_{i}^{H} )}$ |
| (9) | Ω = Ω \ j, ω = ω ∪ j |

| | |
|---|---|
| (10) | end |
| (11) | Output: index set of selected stations ω |

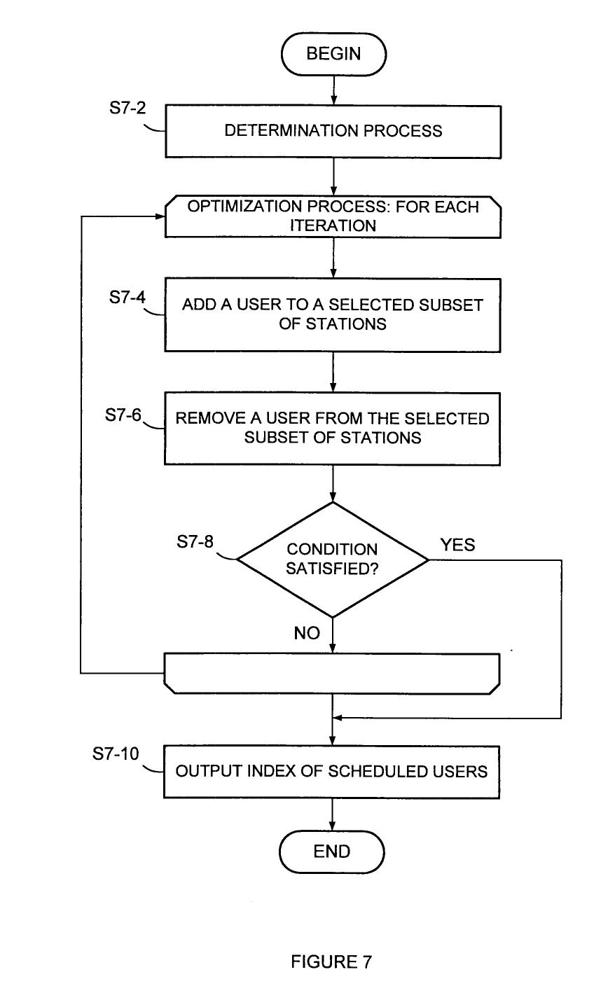

The principles of the methods described above can be extended to an approach which comprises both incremental and decremental station selection. A one-loop, iterative station selection method is now described with reference to the algorithm set out below, as well as the flowchart shown in FIG. 7, which for reasons of clarity does not show each of the steps individually.

In general terms, the algorithm solves an optimisation problem aimed at minimizing the sum MSE of a subset of stations through iterative, incremental and decremental station selection. In essence, the lowest sum MSE represents the highest achievable performance.

The algorithm begins by inputting system information such the channel matrix H (line 1), and then randomly selecting a first subset ω of K stations from a set of K_{T} total stations (line 2). For convenience only, subset ω will be referred to as the ‘selected subset’, while the remaining stations (forming a second subset of stations) are collectively referred to as the ‘remaining subset’, Ω={1, 2, . . . , K_{T}}\Ω(line 3).

Repetitious application of incremental and decremental station selection rules typically requires calculation of a series of matrix inverses, which is computationally expensive. Using a recursive update based on the matrix inversion lemma allows for more efficient computation, i.e. without matrix inversion. The positive-definite matrix A⁻¹ associated with all of the K stations is therefore computed in line 4.

For convenience, the operations of lines (1) to (4) are generally collectively referred to as the determination process, represented by S7-2 in FIG. 7.

The optimization process begins by computing the vector g, for each of the stations of remaining subset Ω (line 6). The ‘best’ station of Ω, namely the station J₁ that minimally contributes to the MSE of selected stations, can thus be identified (line 7) and added to selected subset ω (line 8). The matrix A⁻¹ is updated accordingly (line 9). This incremental station selection step is shown as step S7-4 in FIG. 7.

The next stage of the optimization process involves finding the ‘worst’ station of subset ω. This time the vector gᵢ for each of the stations of subset ω is computed (line 10), so that the station J₂ contributing the largest MSE to subset ω can be identified (line 11) and removed. Here, station J₂ becomes part of the remaining subset Ω (line 12), though J₂ could also be entirely removed from further consideration. Once again, the matrix A⁻¹ is updated to take account of the change. This decremental station selection is shown in as step S7-6 of FIG. 7.

Several iterations can be performed so that the sum MSE converges towards a minimum. The number of iterations can be specified during the determination process (step S7-2), in which case the method checks to see whether the iteration number limit has been reached (step S7-8), and, if so, the optimization process is halted and an index of the selected stations is output (line 16 and step S7-10). Otherwise, another iteration of the optimization process is performed.

Alternatively, or in addition, a situation may occur where the station added to and removed from the selected subset of stations is the same. In such cases, no further iterations needs to be performed since no further improvements can be achieved. Therefore, step S7-8 may comprise making a determination as to whether the added station is the same as the removed station (line 14).

“Algorithm I-C”

| | |
|---|---|
| (1) | Initialization: input H, α, K, number of iterations r |
| (2) | Select set ω of indices of K random stations, H_{K} their channel |
| | matrix |
| (3) | Ω = {1, 2, . . . , K_{T}} \ ω |
| (4) | compute A⁻¹ = (H_{K}^{H}H_{K} + αI_{M})⁻¹ |
| (5) | for l = 1 : r |

| | |
|---|---|
| (6) | compute gᵢ = hᵢA⁻¹ for all i ∈ Ω |
| (7) | ${J}_{1} = arg {max}_{i ∈ Ω} [ {( 1 + {g}_{i} {h}_{i}^{H} )}^{- 1} {‖ {g}_{i} ‖}^{2} ]$ |
| (8) | Ω = Ω \ J₁, ω = ω ∪ J₁ |
| (9) | update A⁻¹ ← A⁻¹ − (1 + g_{J}_{₁}h_{J}_{₁}^{H})⁻¹ g_{J}_{₁}^{H}g_{J}_{₁} |
| (10) | compute gᵢ = hᵢA⁻¹ for all i ∈ ω |
| (11) | ${J}_{2} = arg {min}_{i ∈ Ω} [ {( 1 - {g}_{i} {h}_{i}^{H} )}^{- 1} {‖ {g}_{i} ‖}^{2} ]$ |
| (12) | Ω = Ω ∪ J₂, ω = ω \ J₂ |
| (13) | update A⁻¹ ← A⁻¹ + (1 − g_{J}_{₂}h_{J}_{₂}^{H})⁻¹ g_{J}_{₂}^{H}g_{J}_{₂} |
| (14) | if J₁ == J₂ then stop the algorithm |

| | |
|---|---|
| (15) | End |
| (16) | Output: index set of selected station ω |

Once the first run of the optimization process is ended, further subsets of stations can be (randomly) selected for a second run of the optimization process. These two optimization processes may yield two different optimized subsets, and so the subset with the smaller sum of MSE can be selected. Certain constraints may be implemented to limit the complexity of such an algorithm. For example, the total number of iterations of the first and second optimization processes may be fixed. The modified algorithm is provided below in pseudo-code form.

“Algorithm I-D”

| | |
|---|---|
| (1) | Initialization: input H, α, K, number of iterations r |
| (2) | Select set ω₁ of indices of K random stations, H_{K} their channel |
| | matrix |
| (3) | Ω = {1, 2, . . . , K_{T}} \ ω₁ |
| (4) | compute A⁻¹ = (H_{K}^{H}H_{K} + αI_{M})⁻¹ |
| (5) | for l = 1 : r: |

| | |
|---|---|
| (6) | compute gᵢ = hᵢA⁻¹ for all i ∈ Ω |
| (7) | ${J}_{1} = arg {max}_{i ∈ Ω} [ {( 1 + {g}_{i} {h}_{i}^{H} )}^{- 1} {‖ {g}_{i} ‖}^{2} ]$ |
| (8) | Ω = Ω \ J₁, ω₁ = ω₁ ∪ J₁ |
| (9) | update A⁻¹ ← A⁻¹ − (1 + g_{J}_{₁}h_{J}_{₁}^{H})⁻¹ g_{J}_{₁}^{H}gⱼ_{₁} |
| (10) | compute gᵢ = hᵢA⁻¹ for all i ∈ ω₁ |
| (11) | ${J}_{2} = arg {min}_{i ∈ {ω}_{1}} tr [ {( 1 - {g}_{i} {h}_{i}^{H} )}^{- 1} {g}_{i}^{H} {g}_{i} ]$ |
| (12) | Ω = Ω ∪ J₂, ω₁ = ω₁ \ J₂ |
| (13) | update A⁻¹ ← A⁻¹ +[(1 − gᵢhᵢ^{H})⁻¹∥gᵢ∥²] |
| (14) | if J₁ == J₂ |

| | |
|---|---|
| (15) | store ω₁ and MSE(1) = tr(A⁻¹) |
| (16) | select a new set ω₂ of indices of K random stations from |
| | Ω, H_{K} their channel matrix |
| (17) | set Ω = {1, 2, . . . , K_{T}} \ ω₂ |
| (18) | compute A⁻¹ = (H_{K}^{H}H_{K} + αI_{M})⁻¹ |
| (19) | for l₂ = 1 : r − l |

| | |
|---|---|
| (20) | compute gᵢ = hᵢA⁻¹ for all i ∈ Ω |
| (21) | ${J}_{1} = arg {max}_{i ∈ Ω} [ {( 1 + {g}_{i} {h}_{i}^{H} )}^{- 1} {‖ {g}_{i} ‖}^{2} ]$ |
| (22) | Ω = Ω \ J₁, ω₂ = ω₂ ∪ J₁ |
| (23) | update A⁻¹ ← A⁻¹ − (1 + g_{J}_{₁}h_{J}_{₁}^{H})⁻¹g_{J}_{₁}^{H}g_{J}_{₁} |
| (24) | compute gᵢ = hᵢA⁻¹ for all i ∈ ω₂ |
| (25) | ${J}_{2} = arg {min}_{i ∈ {ω}_{2}} [ {( 1 - {g}_{i} {h}_{i}^{H} )}^{- 1} {‖ {g}_{i} ‖}^{2} ]$ |
| (26) | Ω = Ω ∪ J₂, ω₂ = ω₂ \ J₂ |
| (27) | update A⁻¹ ← A⁻¹ + (1 − g_{J}_{₂}h_{J}_{₂}^{H})⁻¹ g_{J}_{₂}^{H}g_{J}_{₂} |
| (28) | compute MSE(2) = tr(A⁻¹) |
| (29) | if J₁ == J₂ then stop the algorithm |

| | |
|---|---|
| (30) | end %(for secondary loop) |

| | |
|---|---|
| (31) | end %(for checking J₁ == J₂) |
| (32) | [min_MSE, index] = min(MSE(1), MSE(2)) |

| | |
|---|---|
| (33) | end |
| (34) | Output: index set of selected station ω_{index} |

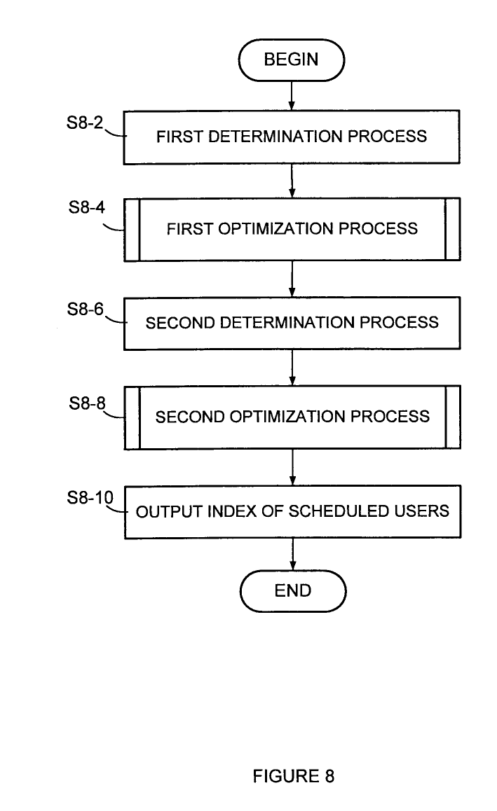

With reference to FIG. 8, the scheduling algorithm initially determines a random subset of stations and computes A⁻¹(lines 1 to 4; step S8-2), and then performs a first run of an optimization process (lines 5 to 14; step S8-4). When the station added to the selected subset of stations is the same as the station removed from that subset (line 14), the corresponding MSE is stored (line 15), and a new selected subset of stations is determined and the corresponding matrix A⁻¹ computed (lines 16 to 18; step S8-6). Then, a second run of an optimization process is performed on the newly determined selected subset of stations (lines 19 to 28; step S8-8), until the added and removed stations are again determined to be the same (line 29). The scheduling algorithm outputs the subset of stations having the lowest MSE (lines 32 to 34; step S8-10).

Thus, each of the first and second determination and optimization processes substantially follow the algorithm set out in respect of FIG. 7.

Both the single- and the multiple-run optimization processes can be improved by reducing the randomness of the selection of the selected subset of stations. For example, the selected subset could be determined to include the station having the largest channel vector norm. The search for the station having largest channel norm slightly increases the complexity. In FIG. 17, for example, algorithms “I-E” and “I-F” refer to algorithms that are similar to “I-C” and “I-D” respectively, but modified as just described.

### Station Scheduling for Two Resource Blocks

Methods of station scheduling for two resource blocks, which could be distributed along either time or frequency axis, is now presented. To simplify the presentation, it is assumed that the subsets of stations to be assigned to the first and second resource blocks are K₁ and K₂ respectively, so that K_{T}=K₁+K₂. Additionally, K₁≦M and K₂≦M. The total number of scheduled stations is K_{T}≦2M for the case of two resource blocks in order to ensure that all the stations can be served.

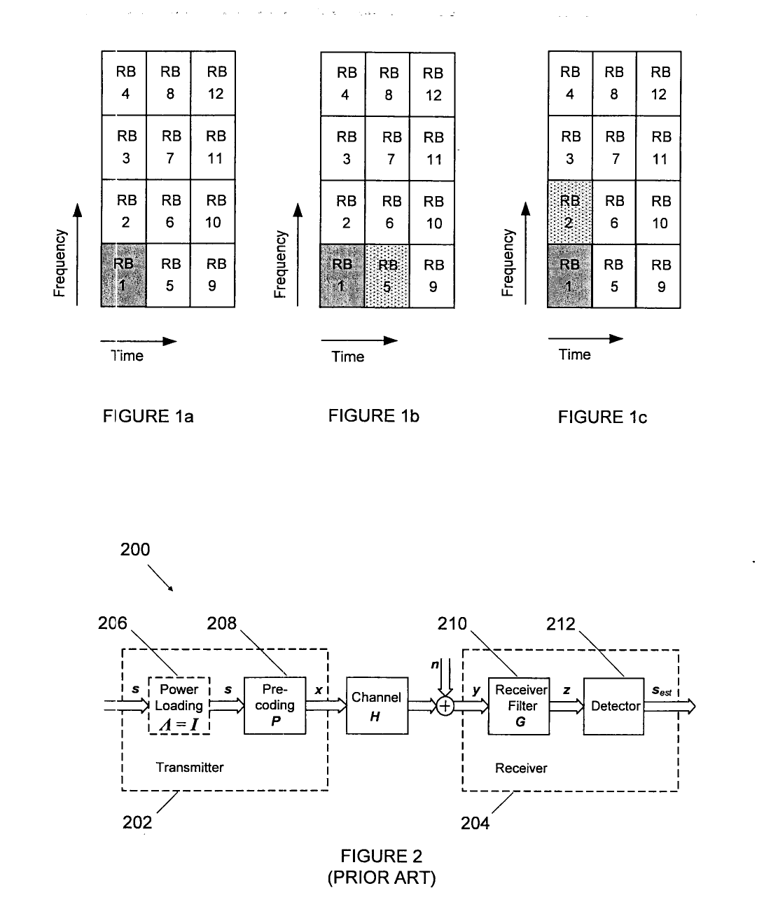

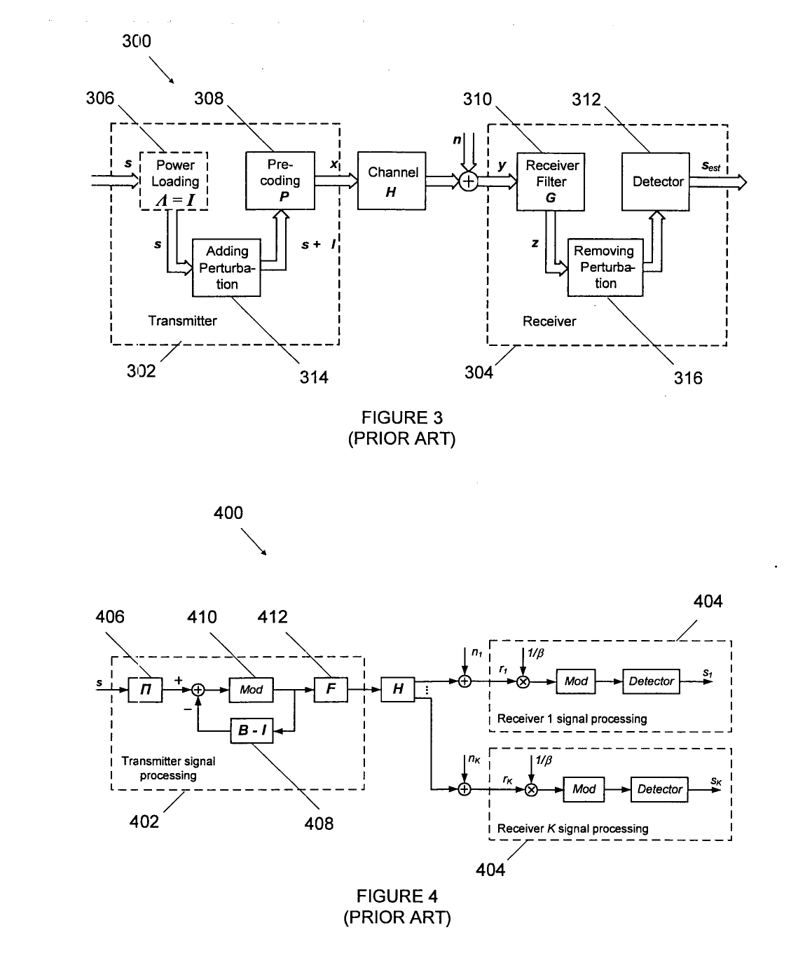

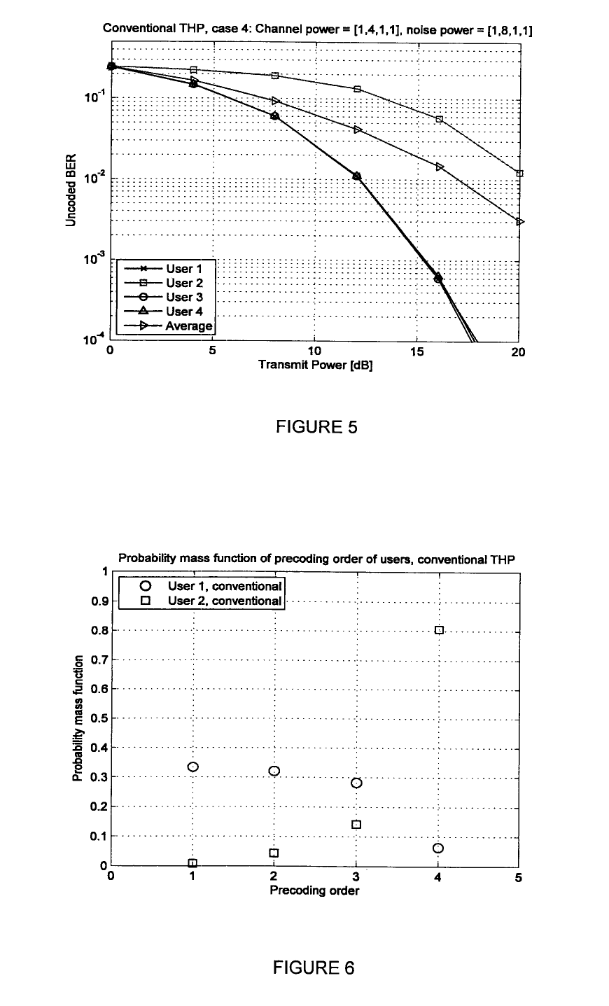

Let H₁, and H₂ be the channel matrices of the stations for two resource blocks that are adjacent along the frequency axis, i.e. FIG. 1c. Recall that these channel matrices are, in general, different. By contrast, for two resource blocks that are consecutive in time, i.e. FIG. 1b, the two channel matrices can be considered to be the same since it can be assumed that the coherent time of channel is greater than the time to transmit the whole data frame. Therefore, the latter situation can be considered to be more general in the sense that if H₂=H₁, the developed algorithms can also be applied to the former situation. For this reason, station scheduling for resource blocks consecutive in frequency is considered in detail.

The first algorithm for two-RB station scheduling is derived from the decremental and incremental algorithms for one-RB developed in the previous section. In particular, initially only the strongest station, i.e. the station with the largest norm of channel vector, is assigned to a selected subset, while K_{T}−1 stations are assigned to a remaining subset. One station is then moved from the remaining subset to the selected subset such that the sum of MSE for the selected and remaining subsets is minimized. This moving process is repeated K₂−1 times, until the number of stations that can be served in each resource block is satisfied. The stations of the selected subset are to be scheduled to one of the resource blocks (‘RB2’) and the stations of the remaining subset are to be scheduled to the other resource block (‘RB1’). (This is different from station scheduling for one resource block where the remaining subset are not scheduled to a resource block.)

In more detail, the set of all stations is Ω₀={1, 2, . . . , K_{T}}, and the channel vector of station k in resource block i (i=1, 2) is h_{i,k}. Let the subset of stations for RB2 be Ω₂, then

$${Ω}_{2} = arg {max}_{k ∈ {Ω}_{0} } {‖ {h}_{2 , k} ‖}^{2} . \qquad ( 32 )$$

The subset of stations for RB1 is Ω₁=Ω₀\Ω₂. We denote the channel matrices of stations in the subset Ω₁ for RB1 and Ω₂ for RB2 as H_{Ω}_{₁} and H_{Ω}_{₂}, respectively. The matrices A₁ and A₂ for RB1 and RB2 are A₁=(H_{Ω}_{₁}^{H}H_{Ω}_{₁}+αI_{M}) and A₂=(H_{Ω}_{₂}^{H}H_{Ω}_{₂}+αI_{M}). Let

g_{i,k}=h_{i,k}Aᵢ⁻¹.

Then, the mathematical description for moving one station from the remaining subset Ω₁ to the selected subset Ω₂ is as follows

$$\begin{matrix}j = arg {min}_{k ∈ {Ω}_{1}} tr ( \frac{{g}_{1 , k}^{H} {g}_{1 , k}}{1 - {g}_{1 , k} {h}_{1 , k}^{H}} - \frac{{g}_{2 , k }^{H} {g}_{2 , k}}{1 + {g}_{2 , k} {h}_{2 , k}^{H}} ) \\ = arg {min}_{k ∈ {Ω}_{1}} ( \frac{{‖ {g}_{1 , k} ‖}^{2}}{1 - {g}_{1 , k} {h}_{1 , k}^{H}} - \frac{{‖ {g}_{2 , k} ‖}^{2}}{1 + {g}_{2 , k} {h}_{2 , k }^{H}} ) .\end{matrix} \qquad ( 33 )$$

After each moving step, the inverses of matrices A₁ and A₂ are updated as

$$\begin{matrix}{A}_{1}^{- 1} ← {A}_{1}^{- 1} + \frac{{g}_{1 , j}^{H} {g}_{1 , j}}{1 - {g}_{1 , j} {h}_{1 , j}^{H}} \\ and & ( 34 ) \\ {A}_{2}^{- 1} ← {A}_{2}^{- 1} - \frac{{g}_{2 , j}^{H} {g}_{2 , j}}{1 + {g}_{2 , j} {h}_{2 , j}^{H}} . & ( 35 )\end{matrix}$$

The above development for two-RB station scheduling is summarized below in pseudo code form.

“Algorithm II-A”

| | |
|---|---|
| (1) | Initialization: input H₁, H₂, α, K_{T}, K₁, K₂ |
| (2) | Ω₀ = {1, 2, . . . , K_{T}} |
| (3) | ${Ω}_{2} = arg {max}_{k ∈ {Ω}_{0}} {‖ {h}_{2 , k} ‖}^{2}$ |
| (4) | Ω₁ = Ω₀ \ Ω₂ |
| (5) | A₁⁻¹ = (H_{Ω}_{₁}^{H}H_{Ω}_{₁} + αI_{M})⁻¹, A₂⁻¹ = (H_{Ω}_{₂}^{H}H_{Ω}_{₂} + αI_{M})⁻¹ |
| (6) | for l = 1 : K₂ − 1 |

| | |
|---|---|
| (7) | compute g_{i,k} = h_{i,k}Aᵢ⁻¹ for all k ∈ Ω₁ and i = 1, 2 |
| (8) | $j = arg {min}_{k ∈ {Ω}_{1}} ( \frac{{‖ {g}_{1 , k} ‖}^{2}}{1 - {g}_{1 , k} {h}_{1 , k}^{H}} - \frac{{‖ {g}_{2 , k} ‖}^{2}}{1 + {g}_{2 , k} {h}_{2 , k}^{H}} )$ |
| (9) | update A₁⁻¹ ← A₁⁻¹ + (1 − g_{1,j}h_{1,j}^{H})⁻¹ g_{1,j}^{H}g_{1,j} |
| (10) | update A₂⁻¹ ← A₂⁻¹ − (1 + g_{2,j}h_{2,j}^{H})⁻¹ g_{2,j}^{H}g_{2,j} |
| (11) | Ω₁ = Ω₁ \ j, Ω₂ = Ω₂ ∪ j |

| | |
|---|---|
| (12) | End |
| (13) | Output: two sets of station indices Ω₁ and Ω₂ |

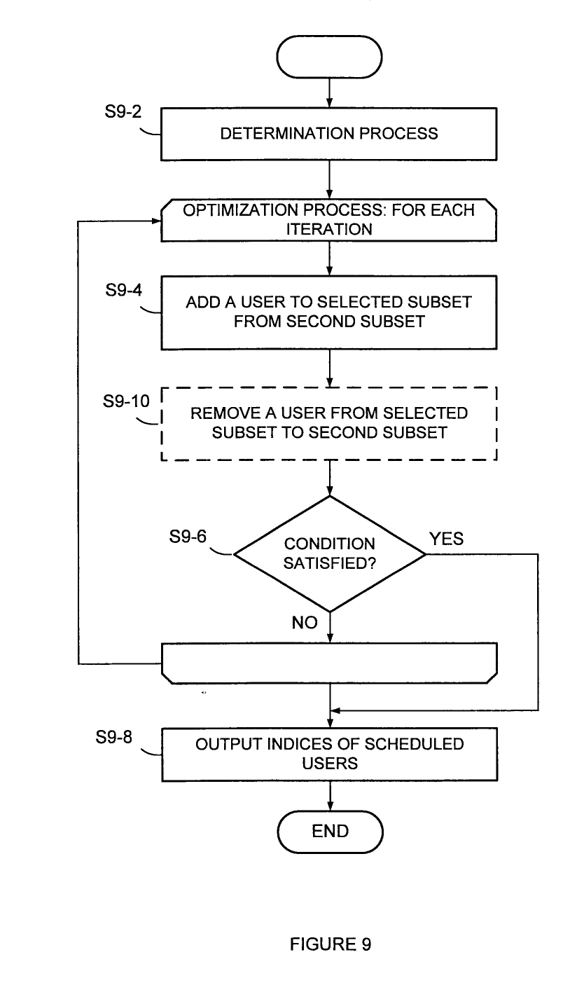

With reference to FIG. 9, the determination process S9-2 here includes determining the station with the largest channel vector norm (line 3). Then, an optimization process commences in which a station is added to the selected subset Ω₂ from the remaining subset Ω₁ (lines 6 to 11; step S9-4). This iterative process is repeated until the number of stations in each subset (RB) meets the requirement (step S9-6).

A further development of the above algorithm for station scheduling for two RBs is presented with reference to the pseudo code below, and also with reference to FIG. 9. Stations are divided into two subsets Ω₁ and Ω₂, each with K₁ and K₂ stations (lines 1 to 4; step S9-2). In this case, there is no particular need to determine the strongest station and so the subsets can be determined at random. In the first iteration of the optimization process, one station is moved from selected subset Ω₁ to remaining subset Ω₂ such that the sum MSE of two subsets is minimized (lines 7 to 11; step S9-4). Then, one station is moved from subset Ω₂ to subset Ω₁, again so that the sum MSE of two subsets is minimized (lines 12 to 15; step S9-10).

“Algorithm II-B”

| | |
|---|---|
| (1) | input H₁, H₂, α, K_{T}, K₁, K₂, number of iterations r |
| (2) | Ω₀ = {1, 2, . . . , K_{T}} |
| (3) | Ω₁ = {1, 2, . . . , K₁} |
| (4) | Ω₂ = Ω₀ \ Ω₁ |
| (5) | A₁⁻¹ = (H_{Ω}_{₁}^{H}H_{Ω}_{₁} + αI_{M})⁻¹, A₂⁻¹ = (H_{Ω}_{₂}^{H}H_{Ω}_{₂} + αI_{M})⁻¹ |
| (6) | for l = 1 : r |

| | |
|---|---|
| (7) | compute g_{i,k} = h_{i,k}Aᵢ⁻¹ for all k ∈ Ω₁ and i = 1, 2 |
| (8) | ${J}_{1} = a rg {min}_{k ∈ {Ω}_{1}} ( \frac{{‖ {g}_{1 , k} ‖}^{2}}{1 - {g}_{1 , k} {h}_{1 , k}^{H}} - \frac{{‖ {g}_{2 , k} ‖}^{2}}{1 + {g}_{2 , k} {h}_{2 , k}^{H}} )$ |
| (9) | update A₁⁻¹ ← A₁⁻¹ + (1 − g_{1,J}_{₁}h_{1,J}_{₁}^{H})⁻¹ g_{1,J}_{₁}^{H}g_{1,J}_{₁} |
| (10) | update A₂⁻¹ ← A₂⁻¹ − (1 + g_{2,J}_{₁}h_{2,J}_{₁}^{H})⁻¹ g_{2,J}_{₁}^{H}g_{2,J}_{₁} |
| (11) | Ω₁ = Ω₁ \ J₁, Ω₂ = Ω₂ ∪ J₁ |
| (12) | compute g_{i,k} = h_{i,k}Aᵢ⁻¹ for all k ∈ Ω₂ and i = 1, 2 |
| (13) | ${J}_{2} = arg {min}_{k ∈ {Ω}_{2}} ( - \frac{{‖ {g}_{1 , k} ‖}^{2}}{1 + {g}_{1 , k} {h}_{1 , k}^{H}} + \frac{{‖ {g}_{2 , k} ‖}^{2}}{1 - {g}_{2 , k} {h}_{2 , k}^{H}} )$ |
| (14) | update A₁⁻¹ ← A₁⁻¹ − (1 + g_{1,J}_{₂}h_{1,J}_{₂}^{H})⁻¹ g_{1,J}_{₂}^{H}g_{1,J}_{₂} |
| | update A₂⁻¹ ← A₂⁻¹ + (1 − g_{2,J}_{₂}h_{2,J}_{₂}^{H})⁻¹ g_{2,J}_{₂}^{H}g_{2,J}_{₂} |
| (15) | Ω₁ = Ω₁ ∪ J₂, Ω₂ = Ω₂ \ J₂ |

| | |
|---|---|
| (16) | end |
| (17) | Output: two sets of station indices Ω₁ and Ω₂ |

As with the single run optimization process for station scheduling for one RB, a situation may arise where stations J₁ and J₂ are the same. Thus, based on the principles introduced for station scheduling for one RB, multiple run optimization processes for station scheduling for two RBs are developed.

In the first run of the optimization process, one station is moved from selected subset Ω₁ to remaining subset Ω₂, and then one station is moved from remaining subset Ω₂ to selected subset Ω₁. In the second run of the optimization process, stations are move in the reverse direction, i.e. first from remaining subset Ω₂ to selected subset Ω₁, then from selected subset Ω₁ to remaining subset Ω₂.

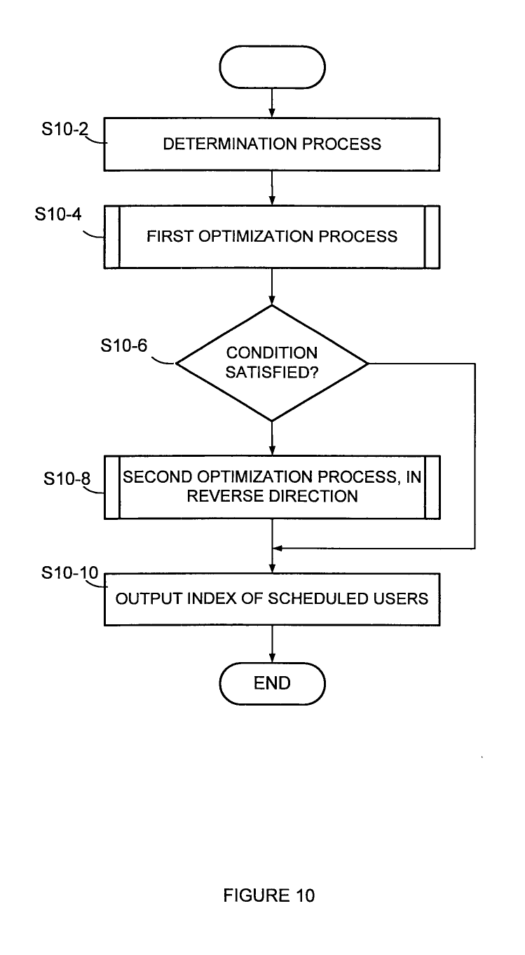

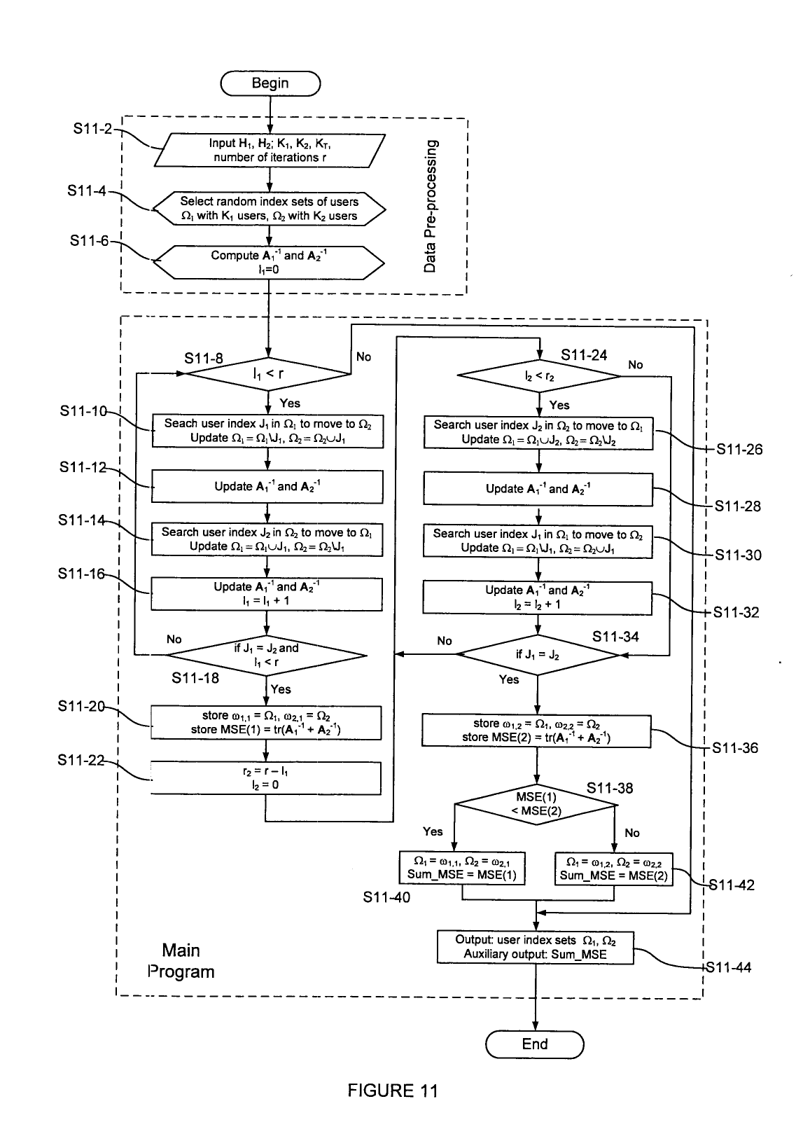

An overview of this method is shown in FIG. 10. The corresponding pseudo code is provided below, cross-referenced with the more detailed flowchart of FIG. 11. The determination process (step S10-2) comprises dividing the stations into two subsets (lines 2 to 4) and here computing A⁻¹ for each subset (line 5). Then, in a first optimization process (initiated at line 6), station J₁ is moved from selected subset Ω₁ to remaining subset Ω₂ (lines 7 to 11) and station J₂ is moved from remaining subset Ω₂ to selected subset Ω₁ (lines 12 to 16). Step S10-4 is substantially similar to steps S9-4 and S9-10 of FIG. 9.

Here, performing a second run of the optimization process (step S10-8) will depend not only on whether the condition J₁=J₂ is met, but also on whether the number of iterations performed so far is less than the total number of iterations specified at the start (lines 17 and 20; step S10-6). If J₁=J₂ and there are still allowable iterations (i.e. l₁<r is true), then the second run of the optimization process may be initiated. However, if the number of allowable iterations is reached before J₁=J₂ (i.e. l₁<r is false) then the scheduled station index is output instead (step S10-10).

The second run of the optimization process (step S10-8) proceeds in a reverse direction to that of the first iteration process. In other words, a station is first moved from subset Ω₂ to subset Ωᵢ (lines 21 to 25), followed by a move of a station from subset Ω₁ to subset Ω₂ (lines 26 to 29). Once again, if J₁=J₂ the run is broken (lines 30 and 31). The total number of iterations generally should remain within the allowable number of iterations.

“Algorithm II-C”

| | | |
|---|---|---|
| (1) | input H₁, H₂, α, K_{T}, K₁, K₂, number of iterations r | S11-2 |
| (2) | Ω₀ = {1, 2, . . . , K_{T}} | |
| (3) | Ω₁ = {1, 2, . . . , K₁} | S11-4 |
| (4) | Ω₂ = Ω₀ \ Ω₁ | |
| (5) | A₁⁻¹ = (H_{Ω}_{₁}^{H}H_{Ω}_{₁} + αI_{M})⁻¹, A₂⁻¹ = (H_{Ω}_{₂}^{H}H_{Ω}_{₂} + αI_{M})⁻¹ | S11-6 |
| (6) | for l₁ = 1 : r | S11-8 |

| | | |
|---|---|---|
| (7) | compute g_{i,k} = h_{i,k}Aᵢ⁻¹, ∀k ∈ Ω₁ and i = 1, 2 | |
| (8) | ${J}_{1} = arg {min}_{k ∈ {Ω}_{1}} ( \frac{{‖ {g}_{1 , k} ‖}^{2}}{1 - {g}_{1 , k} {h}_{1 , k}^{H}} - \frac{{‖ {g}_{2 , k} ‖}^{2}}{1 + {g}_{2 , k} {h}_{2 , k}^{H}} )$ | S11-10 |
| (9) | update A₁⁻¹ ← A₁⁻¹ + (1 − g_{1,J}_{₁}h_{1,J}_{₁}^{H})⁻¹ g_{1,J}_{₁}^{H}g_{1,J}_{₁} | |
| (10) | update A₂⁻¹ ← A₂⁻¹ − (1 + g_{2,J}_{₁}h_{2,J}_{₁}^{H})⁻¹ g_{2,J}_{₁}^{H}g_{2,J}_{₁} | S11-12 |
| (11) | Ω₁ = Ω₁ \ J₁, Ω₂ = Ω₂ ∪ J₁ | |
| (12) | compute g_{i,k} = h_{i,k}Aᵢ⁻¹, ∀k ∈ Ω₂ and i = 1, 2 | |
| (13) | ${J}_{2} = arg {min}_{k ∈ {Ω}_{2}} ( - \frac{{‖ {g}_{1 , k} ‖}^{2}}{1 + {g}_{1 , k} {h}_{1 , k}^{H}} + \frac{{‖ {g}_{2 , k} ‖}^{2}}{1 - {g}_{2 , k} {h}_{2 , k}^{H}} )$ | S11-14 |
| (14) | update A₁⁻¹ ← A₁⁻¹ − (1 + g_{1,J}_{₂}h_{1,J}_{₂}^{H})⁻¹ g_{1,J}_{₂}^{H}g_{1,J}_{₂} | |
| (15) | update A₂⁻¹ ← A₂⁻¹ + (1 − g_{2,J}_{₂}h_{2,J}_{₂}^{H})⁻¹ g_{2,J}_{₂}^{H}g_{2,J}_{₂} | S11-16 |
| (16) | Ω₁ = Ω₁ ∪ J₂, Ω₂ = Ω₂ \ J₂ | |
| (17) | if J₁ == J₂ and l₁ < r | S11-18 |

| | | |
|---|---|---|
| (18) | store MSE(1) = tr(A₁⁻¹ + A₂⁻¹) | S11-20 |
| (19) | store ω_{1,1} = Ω₁, ω_{2,1} = Ω₂ | |
| (20) | for l₂ = 1 : r − l₁ | S11-22/24 |

| | | |
|---|---|---|
| (21) | compute g_{i,k} = h_{i,k}Aᵢ⁻¹, ∀k ∈ Ω₂, i = 1, 2 | |
| (22) | ${J}_{2} = arg {min}_{k ∈ {Ω}_{2}} ( - \frac{{‖ {g}_{1 , k} ‖}^{2}}{1 + {g}_{1 , k} {h}_{1 , k}^{H}} + \frac{{‖ {g}_{2 , k} ‖}^{2}}{1 - {g}_{2 , k} {h}_{2 , k}^{H}} )$ | S11-26 |
| (23) | update A₁⁻¹ ← A₁⁻¹ − (1 + g_{1,J}_{₂}h_{1,J}_{₂}^{H})⁻¹ g_{1,J}_{₂}^{H}g_{1,J}_{₂} | |
| (24) | update A₂⁻¹ ← A₂⁻¹ + (1 − g_{2,J}_{₂}h_{2,J}_{₂}^{H})⁻¹ g_{2,J}_{₂}^{H}g_{2,J}_{₂} | S11-28 |
| (25) | Ω₁ = Ω₁ ∪ J₂, Ω₂ = Ω₂ \ J₂ | |
| (26) | compute g_{i,k} = h_{i,k}Aᵢ⁻¹, ∀k ∈ Ω₁, i = 1, 2 | S11-30 |
| (27) | ${J}_{1} = arg {min}_{k ∈ {Ω}_{1}} ( \frac{{‖ {g}_{1 , k} ‖}^{2}}{1 - {g}_{1 , k} {h}_{1 , k}^{H}} - \frac{{‖ {g}_{2 , k} ‖}^{2}}{1 + {g}_{2 , k} {h}_{2 , k}^{H}} )$ | |
| (28) | update A₁⁻¹ ← A₁⁻¹ + (1 − g_{1,J}_{₁}h_{1,J}_{₁}^{H})⁻¹ g_{1,J}_{₁}^{H}g_{1,J}_{₁} | S11-32 |
| | update A₂⁻¹ ← A₂⁻¹ − (1 + g_{2,J}_{₁}h_{2,J}_{₁}^{H})⁻¹ g_{2,J}_{₁}^{H}g_{2,J}_{₁} | |
| (29) | Ω₁ = Ω₁ \ J₁, Ω₂ = Ω₂ ∪ J₁ | |
| (30) | if J₁ == J₂ break | S11-34 |

| | | |
|---|---|---|
| (31) | end % secondary loop | |
| (32) | MSE(2) = tr(A₁⁻¹ + A₂⁻¹) | S11-36 |
| (33) | ω_{1,2} = Ω₁, ω_{2,2} = Ω₂ | |

| | |
|---|---|
| (34) | end |

| | | |
|---|---|---|
| (35) | end % primary loop | |
| (36) | [sum_MSE, idx]=min(MSE) | S11-38 |
| (37) | Output: station index sets Ω₁ = ω_{1,idx}, Ω₂ = ω_{2,idx}, and sum_MSE | S11-44 |

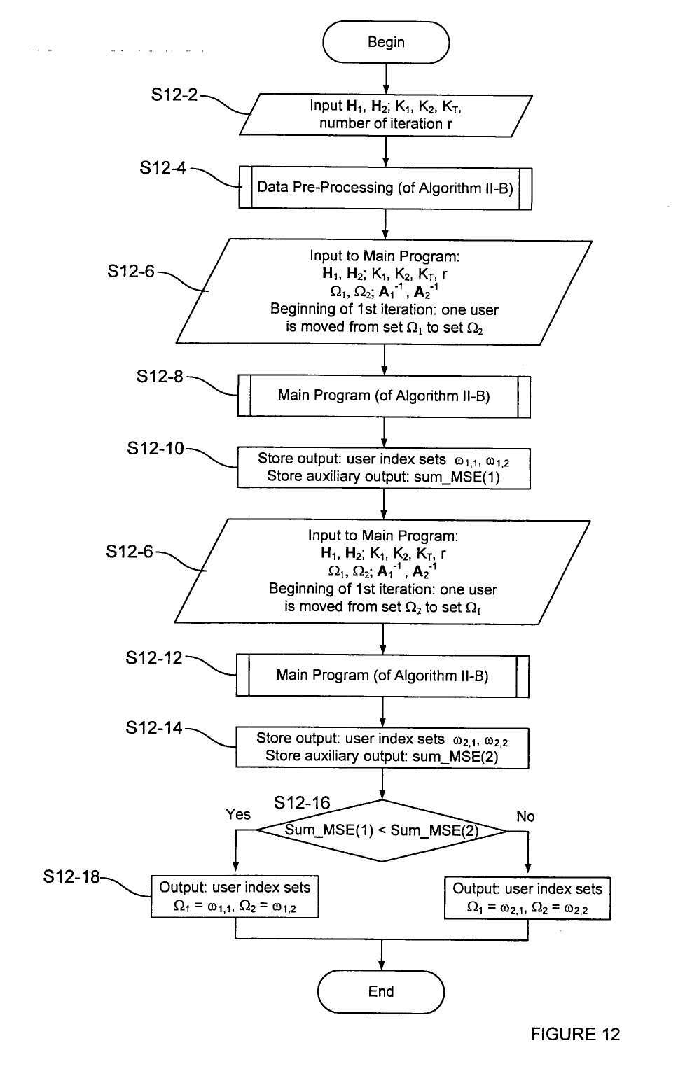

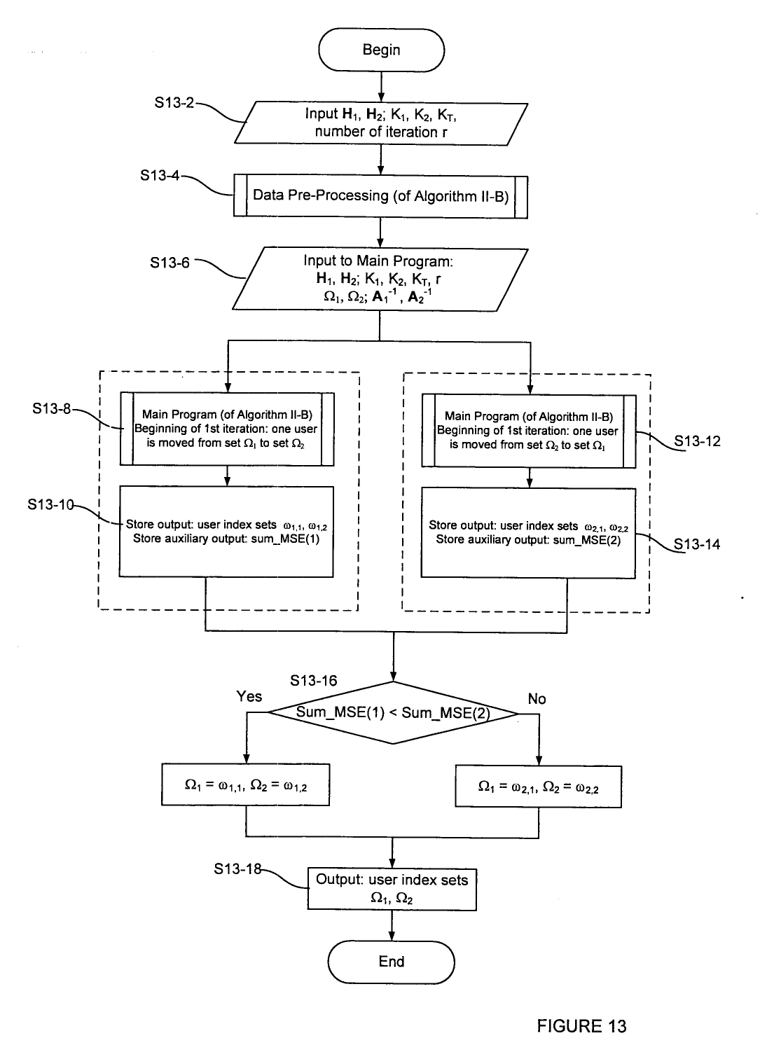

It is also possible that the same two subsets resulting from a single determination process can be used for two different optimization runs. For example, stations could be moved from selected subset Ω₁ to subset Ω₂ in a first run of an optimization process, and moved from subset Ω₂ to subset Ω₁ in a second run of an optimization process, where the first and second runs of the optimization process are performed either in series or in parallel. The respective flowcharts are shown in FIGS. 12 and 13 (“Algorithm II-D”).

The determination process comprises preparing a set of input data, determining the subsets Ω₁, Ω₂ and computing A₁⁻¹, A₂⁻¹ (steps S12-2 to S12-6 in FIG. 12; steps S13-2 to S13-6 in FIG. 13), which will feed first and second runs of the optimization process (steps S12-8 and S12-12 in FIG. 12; steps S13-8 and S13-12 in FIG. 13). In the first run of the optimization process, a station is moved from subset Ω₁ to subset Ω₂ per iteration, while in the second run of the optimization process, a station is moved from subset Ω₂ to subset Ω₁ per iteration. The resulting MSE values are compared (S12-16; S13-16) and the subsets corresponding to the minimized value scheduled for access (S12-18; S13-18).

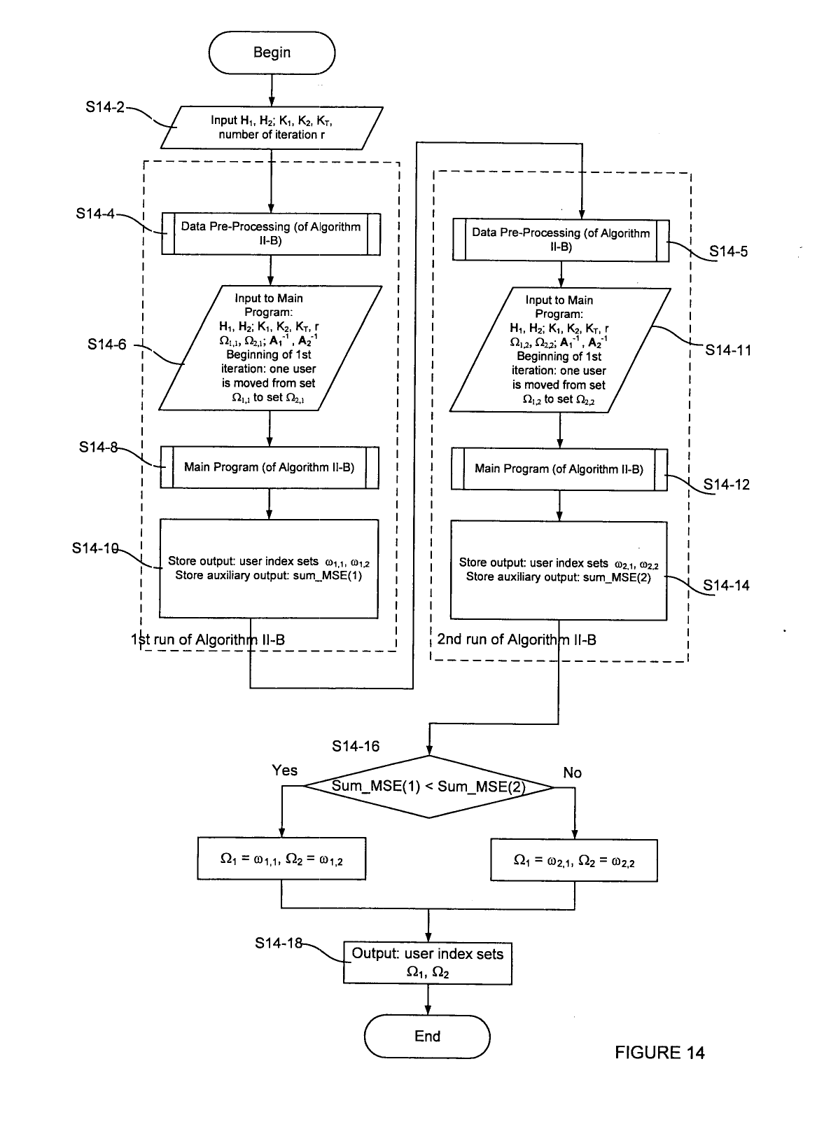

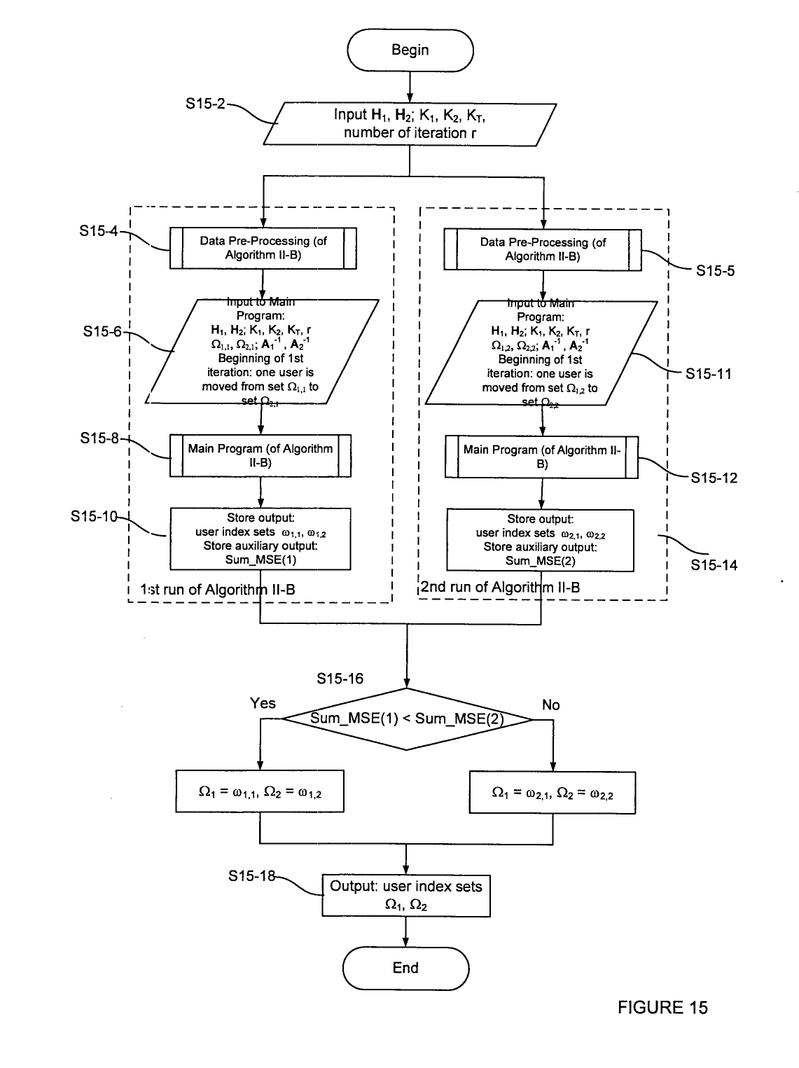

This approach can be modified such that the first and second runs of the optimization process utilise the subsets determined by two different determination processes. In essence, the process shown in FIG. 9 is performed several times, in series or in parallel. The corresponding flowcharts are shown in FIGS. 14 and 15 (“Algorithm II-E”), where like numbers refer to like steps of FIGS. 12 and 13, but with modified prefixes to take account of the Figure numbering. Additionally, since two determination process are implemented, FIGS. 14 and 15 show an additional pre-processing step (steps S14-5 and S15-5) and an additional input step (steps S14-11 and S15-11). Furthermore, the adding and removing in the second run of the optimization process (step S14-12 and step S5-12) are not performed in reverse.

Station Scheduling for More than Two Resource Blocks

This section briefly discusses how the station scheduling methods described above can be modified for station scheduling for more than two RBs. Assuming the case for three RBs, which can serve K₁, K₂, K₃ stations respectively. The total number of stations is therefore K_{T}=K₁+K₂+K₃.

There are several strategies to apply the above optimization processes to this problem. Here one exemplary approach is described.

At first, stations are randomly assigned to three subsets Ω₁, Ω₂, Ω₃ with K₁, K₂, K₃ stations, respectively. Then, one station may be moved from subset Ω₁ to either subset Ω₂ or subset Ω₃ to optimize the performance metric in a similar fashion as for the cases of one or two RBs. If the station is move from subset Ω₁ to subset Ω₂, then, in the next step, one station might be moved from subset Ω₂ to subset Ω₃ to optimize the performance metric. Then a station from subset Ω₃ might be moved to subset Ω₁ to optimize the performance metric. These moving steps can be performed iteratively several times to improve the system performance. Although many variations will be conceivable to the skilled person, this general principle is followed.

### Simulation Results

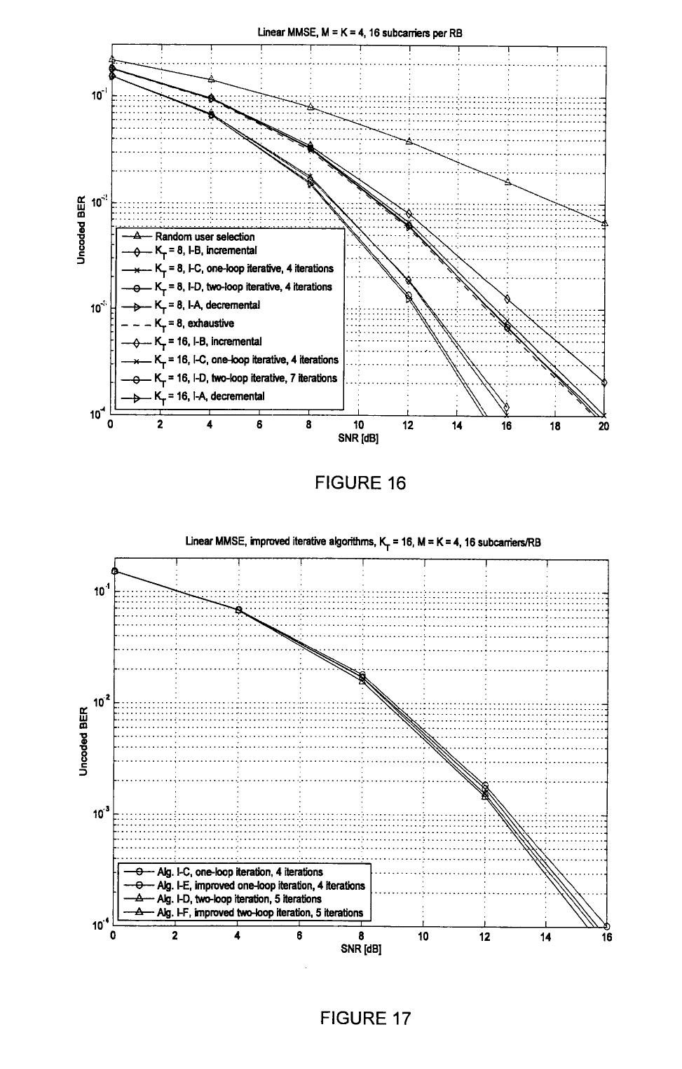

Simulation results of the performances of the proposed algorithms are shown in FIGS. 16 to 18. The algorithms are evaluated in an OFDM channel with ITU Pedestrian-B power and delay profiles. Each resource block comprises 16 consecutive subcarriers and 200F DM symbols. The number of subcarriers is 1024.

The performances of station scheduling algorithms for one RB are shown in FIG. 16. Decremental station selection has the best performance, followed closely by the two-loop optimization process station selection. Significantly, these approaches nearly achieve the performance of exhaustive station selection, which has high complexity.

FIG. 17 presents performances of the two-run optimization process algorithms. This reveals that a SNR gain, albeit small, can be obtained.

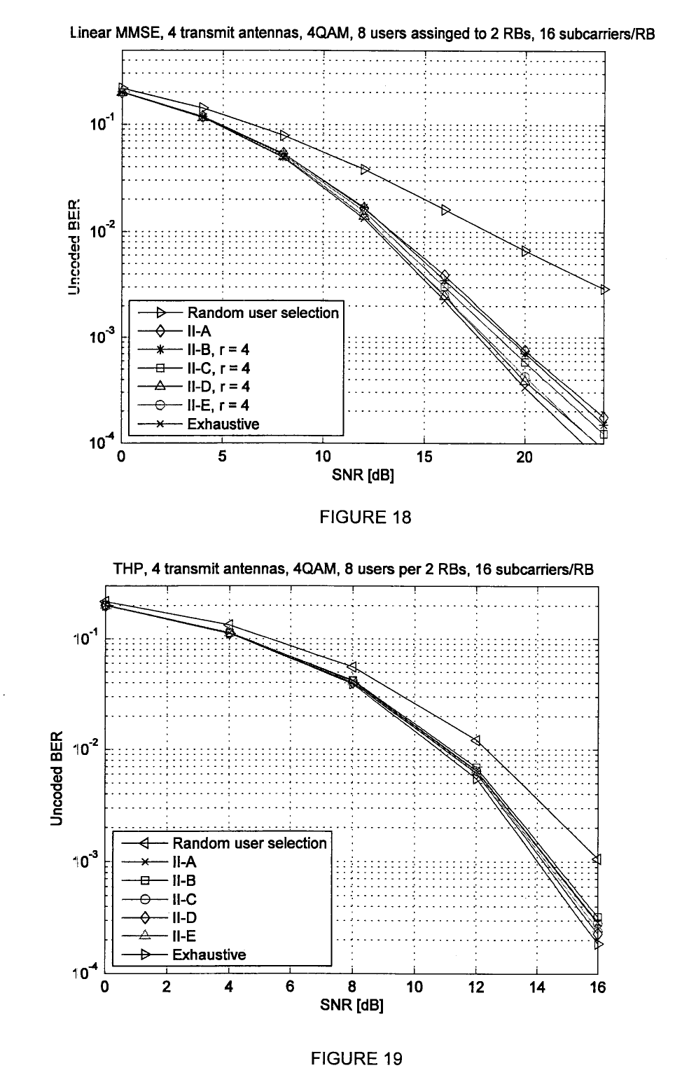

Simulation results for two-RB station scheduling algorithms are also presented in FIG. 18 for linear MMSE precoding. In the simulations, the number of transmit antennas is M=4, K_{T}=8 stations are to be assigned to 2 neighbour RBs with K₁=K₂=4.

From the results, algorithms described by flowcharts in FIGS. 12 and 13 (‘II-D’ in FIG. 18) and algorithms described by flowcharts in FIGS. 14 and 15 (‘II-E’ in FIG. 18) have similar performances and are only 0.2 dB away from that of highly complex exhaustive search. The proposed algorithms yield significant gains compared with random station selection, more than 5 dB at uncoded BER of 10⁻².

Application to Non-Linear Precoding with Uniform Noise Power

The previous sections have discussed station scheduling in the context of linear precoding, in particular linear MMSE precoding. However, station scheduling for linear MMSE, precoding can be readily extended to nonlinear MMSE-based or ZF-based precoding. Here, Tomlinson-Harashima (TH) precoding is considered. The MMSE metric of MMSE-TH precoding is quite different from that of linear MMSE precoder, due to the station permutation and signal shaping processes. Nevertheless, the algorithms developed in the previous sections can still be applied to TH precoding. Moreover, although application of the above described algorithms to TH precoding may not be considered optimal, simulation results (shown in FIG. 19) reveal that, for at least the two-RB station scheduling algorithms, substantial gains can be achieved.

More specifically, it is evident that for nonlinear TH precoding, the proposed station scheduling algorithms also nearly achieve the performance of exhaustive search, which is about 0.2 dB loss at uncoded BER of 10⁻². At the same BER, the proposed algorithms bring more than 1 dB gain compared with random station selection. Thus, even if other algorithms might be specifically designed for nonlinear precoding, performance improvements would appear to be negligible.

Station Scheduling with Non-Uniform Noise Powers

The foregoing sections present station scheduling algorithms when all stations have the same unit noise power. If stations' noise powers are different, the above algorithms are generally not applicable. However, the methods can still be employed for precoding methods with ZF criterion, where the noise powers are omitted. Nevertheless, subsequent sections will show that the described algorithms can be used in the most general case of MMSE precoders, where stations have different powers, by a special design of receiver filter matrix G.

A detailed description is provided in the following sections. In short, the diagonal matrix G is set to

G=Rₙ^{-1/2}. (36)

Thus, the receiver filter of each station is simply equal to the inverse of the square root of noise power. Substituting G in equation (36) into equation (7), we obtain

$$ψ = tr [ {( \frac{{E}_{tr }}{K} {GHH}^{H} {G}^{H} + {I}_{K} )}^{- 1} ] . \qquad ( 37 )$$

Letting

$$\hat{H} = GH ,$$

then

$$ψ = tr [ {( \frac{{E}_{tr}}{K} \hat{H} {\hat{H}}^{H} + {I}_{K} )}^{- 1} ] . \qquad ( 38 )$$

The expressions of sum of MSE in equations (7) and (38) have the same format. Thus, by a special design of receiver filter in equation (36) and using new equivalent channel Ĥ=GH, we can obtain a similar formula of sum of MSE metric for unit noise power case. Thus all the developed station selection algorithms can be seemingly applied.

### Station Design

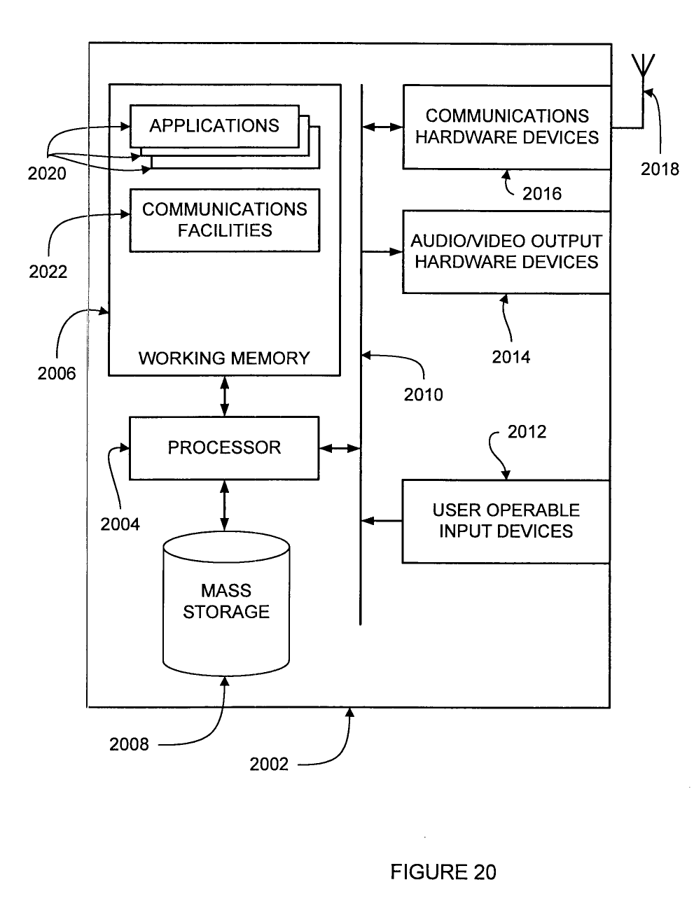

FIG. 20 illustrates schematically a station 2002 comprising a processor 2004 operable to execute machine code instructions stored in a working memory 2006 and/or retrievable from a mass storage device 2008. By means of a general-purpose bus 2010, user operable input devices 2012 are in communication with the processor. The user operable input devices comprise, in this example, a keyboard and a touchpad, but could include a mouse or other pointing device, a contact sensitive surface on a display unit of the device, a writing tablet, speech recognition means, haptic input means, or any other means by which a user input action can be interpreted and converted into data signals.

Audio/video output devices 2014 are further connected to the general-purpose bus, for the output of information to a user. Audio/video output devices include a visual display unit, and a speaker, but can also include any other device capable of presenting information to a user.

A communications unit 2016 is connected to the general-purpose bus, and further connected to an antenna 2018. By means of the communications unit and the antenna, the station is capable of establishing wireless communication with another station (for example, a base station). The communications unit is operable to convert data passed thereto on the bus to an RF signal carrier in accordance with a communications protocol previously established for use by a system in which the station is appropriate for use.

In the station of FIG. 20, the working memory stores user applications 2020 which, when executed by the processor, cause the establishment of a user interface to enable communication of data to and from a user. The applications thus establish general purpose or specific computer implemented utilities and facilities 2022 that might habitually be used by a user.

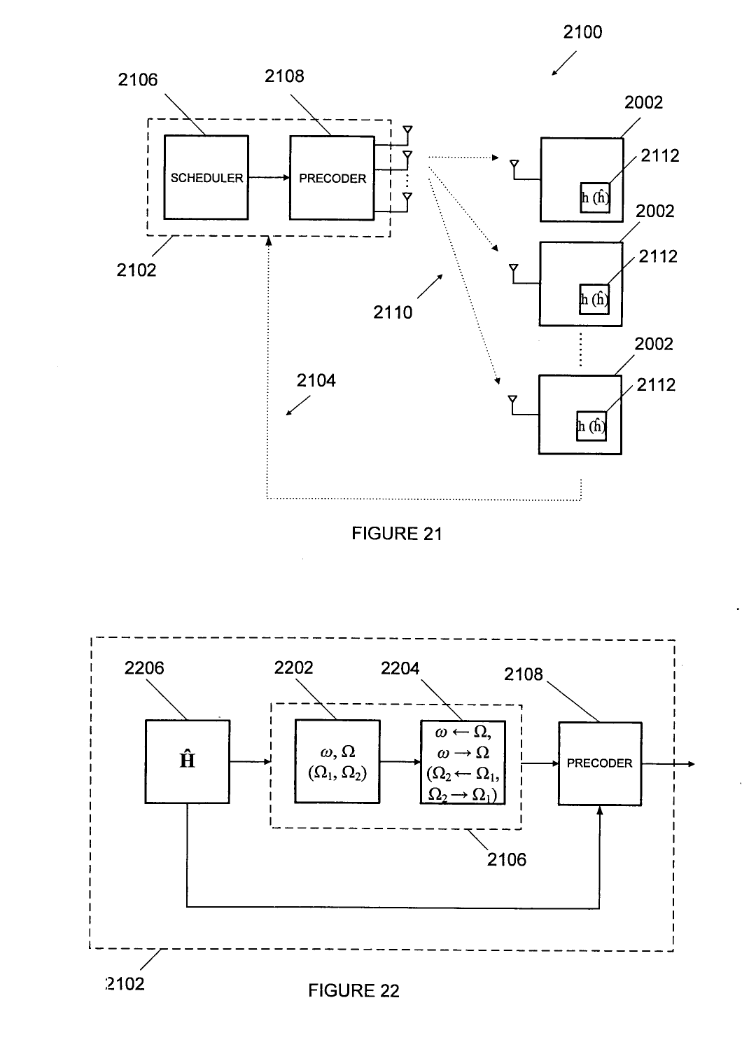

FIG. 21 shows a communication system 2100 comprising a plurality of stations 2002 including a base station 2102. In system 2100, the stations 2002 have feedback circuit 2112 for generating the information to be fed back to the base station, depicted by a single dashed arrow 2104 for clarity. This information may comprise a channel estimate, or a weighted channel estimate in the case where users' power loading is taken into consideration, as will be described in due course. One or both of the scheduler 2106 and precoder 2108 utilise the information for scheduling stations and precoding data 2110. In more detail, and with reference to FIG. 22, the scheduler 2106 comprises means for performing a determination process 2202 and means for performing an optimization process 2204, as described. Where user stations have non-uniform noise powers, the base station 2102 can be further provided with means for determining a channel matrix using the feedback information, the output of which is used by the scheduling and precoding means.

### Precoding Order of Stations in TH Precoding

One of the main factors determining the performance of the conventional TH precoding is the ordering of the stations. However, since finding an optimal ordering will involve an exhaustive search over K! possible arrangements, a suboptimal ordering is usually employed. Combinations of THP with zero-forcing (ZF-THP) and THP with minimum mean square error (MMSE-THP) are examples of such suboptimal ordering.

Here, a method of gain adjusted TH precoding (GA-THP) is described, in which a gain control factor is introduced at the receiver.

The main issue with the MMSE-based TH precoding is that the individual stations' noise powers are not taken into account. This may lead to suboptimal order if the noise powers of stations are different. This problem is overcome by introducing a gain control factor gₖ to the received signals of stations as

gₖ=vₖ⁻¹. (39)

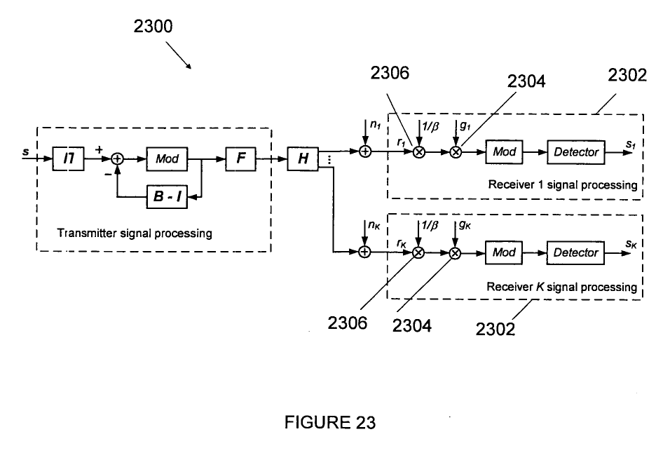

The modification to the receiver station 2302 is sketched in FIG. 23, where a multiplication module 2304 is added at the receiver side to adjust the received signals. In fact, module 2304 and multiplication module 2306 (which applies a normalization scalar to the received signal) can be combined into one, but for the sake of clarity, they are separately illustrated.

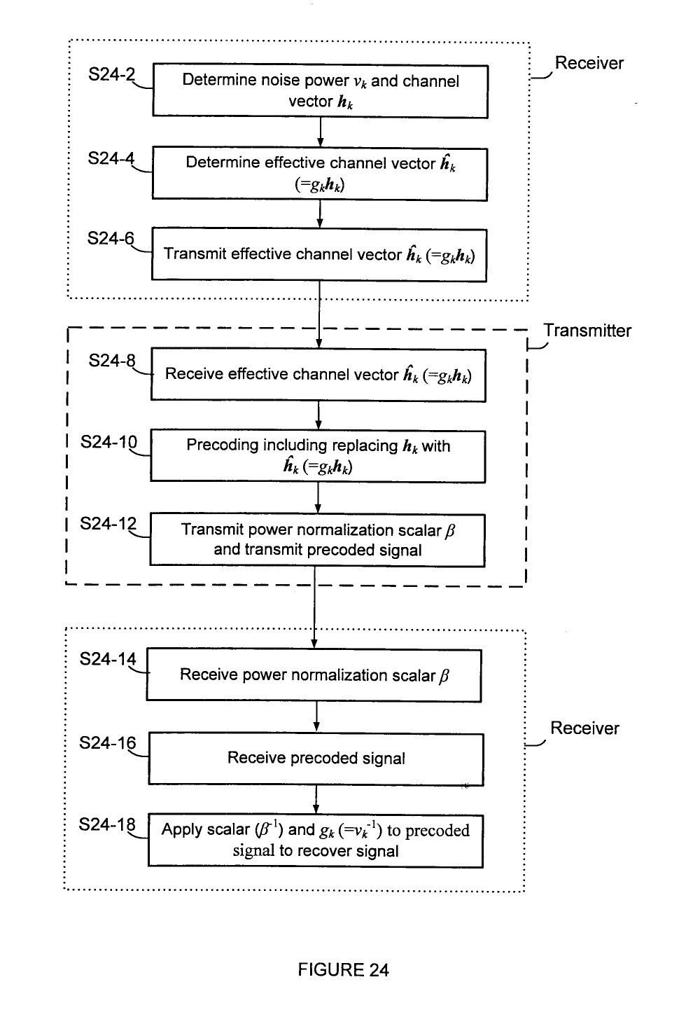

A flowchart of the feedback, precoding and recovery processes at a receiver station and a transmitter station (e.g. Base Station) is shown in FIG. 24. In the present approach, the BS makes use of the effective channel

$${\hat{h}}_{k} = {g}_{k} {h}_{k} .$$

Thus, distinct noise power values do not need to be sent back to the BS, which helps to reduce the feedback overhead in the uplinks.

The receiver determines a noise power vₖ and channel vector hₖ (step S24-2), on the basis of which an effective channel vector ĥₖ (=gₖ hₖ) is determined (step S24-4). The effective channel vector is then transmitted to the base station (step S24-6).

The BS uses the received effective channel vector (step S24-8) during THP precoding (step S24-10). By replacing the channel vector hₖ with an effective channel vector ĥₖ, which incorporates a measure of the station's noise power vₖ (gₖ=vₖ⁻¹), the precoding operation will now take into account the noise power of each station (as well as the instantaneous channel). The precoded signal is then sent to the receiver, in addition to a power normalization scalar β (which each receiver uses in the recovery of the precoded transmitted data) (step S24-12). For systems in which all stations are aware of GA-TH precoding, the same power normalization scalar β can be sent to all stations.

The receiver receives the power normalization scalar β (S24-14) and the precoded signal (S24-16). The precoded signal is then weighted (multiplied) by the power normalization scalar (β⁻¹), to correct for the amplitude of the desired signal which follows from the transmit power constraint, and by the gain control factor scalar gₖ, to correct for the noise powers and channel gains introduced at the precoding stage. The scalars can be applied separately or as a single scalar, e.g. gₖ/β.

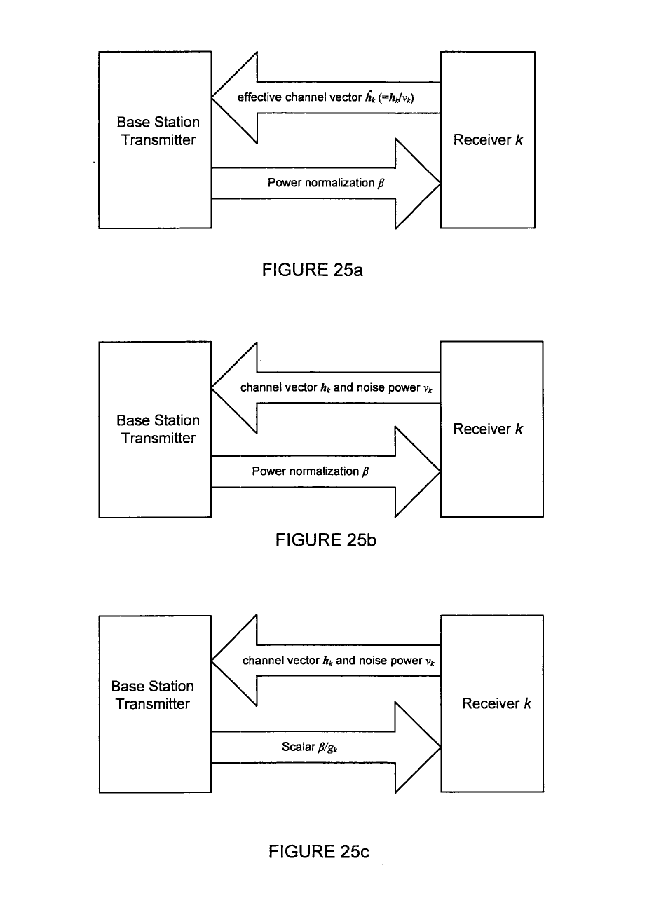

An overview of the signalling exchanges between the BS transmitter and a station for the above approach is also shown in FIG. 25a.

The described technique can also be applied to systems employing conventional TH precoding, which are referred to as ‘legacy systems’. FIG. 25b depicts a signalling exchange between the BS and a receiver station for conventional cases. The receiver station sends back its noise power vₖ and channel vector hₖ separately, while the BS informs the station(s) of the value β for reconstructing the transmitted signal.

For implementing the described approach, the scalar β usually sent by the BS is replaced by β/gₖ (FIG. 25c). The reason that the scalar β/gₖ is preferred is that in legacy systems stations know that the base station sends β. However, alternatively, the base station could send 1/β, in which case gₖ/β could be sent to users. The legacy stations can use the received coefficient β/gₖ for other signal processing stages. The values of coefficient β/gₖ could be sent to UE either by analog pilot signals or digital signal on some dedicated channels. Various methods of conveying β/gₖ to the UEs will be apparent to the skilled person and so will not be described here.

An explanation of how the precoding matrices are changed after introducing the gain control factors is now provided. For a station k, the effective channel (row) vector hₖ becomes

$${\hat{h}}_{k} = {g}_{k} {h}_{k} ;$$

the effective noise power is now unity as (gₖvₖ)²=1. Thus, the effective channel power is σ_{eff,k}=(gₖσₖ)²=σₖ²/vₖ². The effective channel matrix of all stations is

$$\hat{H} = [ \begin{matrix}{\hat{h}}_{1} \\ ⋮ \\ {\hat{h}}_{K}\end{matrix} ] . \qquad ( 40 )$$

Now the MMSE-based TH precoding described earlier can be reused. There are two changes. First, the channel matrix H is replaced by the effective channel matrix Ĥ. Second, the effective noise power of all stations is 1. In particular, the matrix Φ in equation (10) becomes

$$Φ = \hat{H} {\hat{H}}^{H} + \frac{K}{{E}_{tr}} I . \qquad ( 41 )$$

In this way, the station ordering process will take into account both the instantaneous channel and noise power of each station during the computation of the permutation and precoding matrices. Thus, the likelihood that the station with the worst effective channel power σ_{eff,k}² is selected first will decrease, and the average BER of all stations will be improved.

Although the present approach is described in the context of GA-TH precoding, it can be readily extended to other linear MMSE precoding, such as that described in Joham et al. (2004), and nonlinear MMSE-based vector perturbation precoding, such as that described in Schmidt et al.

The values of gain coefficients gₖ could be varied. In equation (39), the gain coefficients gₖ are set to vₖ⁻¹ such that the precoding order of stations will be statistically changed. By defining gₖ=aₖvₖ⁻¹, where aₖ is any positive real number, there is a greater degree of freedom to modify the precoding orders of stations (by choosing the values of aₖ).

The described technique makes use of stations' noise (thermal noise plus interference) powers in formulating the precoder. In fact, other MMSE-based linear and nonlinear precoders also require the knowledge of stations' noise powers. Below, exemplary noise powers and ways of measuring it at the receiver are presented.

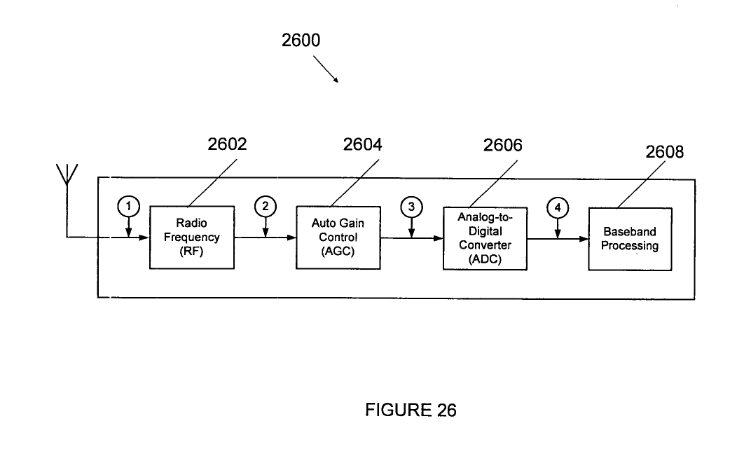

A simplified block diagram of a receiver 2600 is shown in FIG. 26. Theoretically, the noise powers can be measured at any points of the receive chain (indicated by reference points ‘1’, ‘2 ’, ‘3 ’ and ‘4 ’) but with different values at different points. This is because the radio frequency (RF) 2602, auto gain control (AGC) 2604, and analog-to-digital converter (ADC) 2606 modules may also introduce noise and distortion. For example, at reference point 4, where channel and noise powers are measured and used by baseband processing (BP) module 2608, the values of channel and noise power take into account all the noise (thermal noise plus interference) and distortion of the transmission chain from transmitter to the receiver up to this point, which is to say the chain between the BP module of the BS (not shown) and the BP module of the receiver station.

In the chain of modules, when the AGC module has established its gain level, the noise power and channel coefficients can be measured. After that, the AGC gain factor might be assumed to be constant during the reception of an OFDM data frame precoded by the described technique. This is an exact assumption for noise measurement, interference measurement and channel measurement and estimation. This requirement can normally be me since it is assumed that the variation of the environment is substantially unchanged during the transmission of an OFDM frame of several OFDM symbols. This condition also applies for other measurements and feedback, including channel measurements and feedback for other precoding implementations.

In cases where an element of the transmission chain has changed, for example where the environment has changed or where the AGC gain has changed, substantially all the measurements including noise, interference, and CSI are preferably re-measured and re-estimated, as with any current and conventional operation.

There are several ways to measure the noise power measurement in practice, which will be known to the skilled person. For practical purposes, but without loss of generality, two exemplary methods of measuring the noise power are defined in the IEEE 802.16e Standard (IEEE Standard for Local and Metropolitan Area Networks, Part 16: Air Interface for Fixed and Mobile Broadband Wireless Access Systems, IEEE Std 802.16e-2005 and IEEE Std 802.162004/Corl-2005, 2005.

The noise power can be measured by taking the received signals of unmodulated subcarriers (no data) in the preamble of data frames; for error free packet, the noise is simply a difference between the received signal and error-free recovered signal. Then the noise power can be determined by taking the variance of noise signals.

### Simulation Results

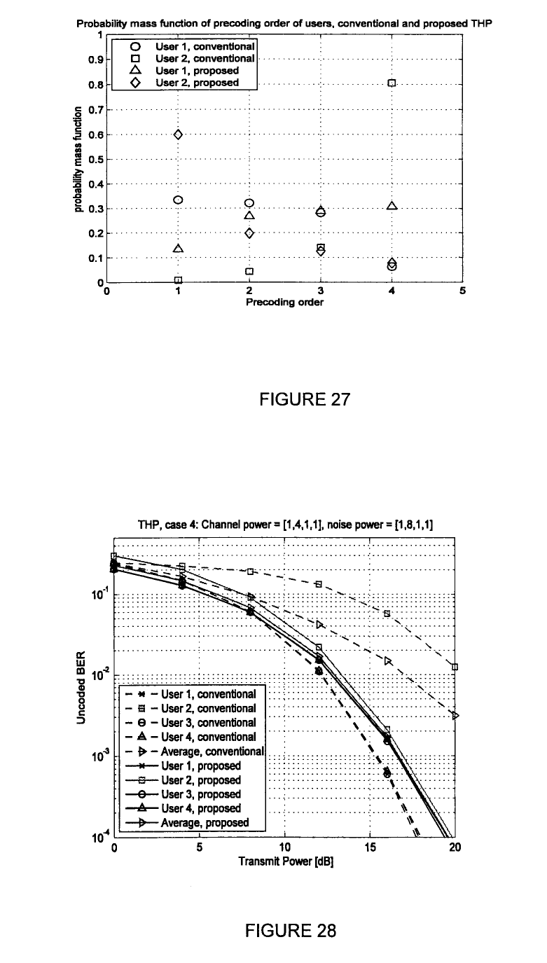

Simulation results for the described GA-TH precoding method using the same channel and noise power provided earlier are given in FIG. 27 and FIG. 28, and reveal the SNR advantage of the described method. The performance metric is the average BER of all stations since this metric is relevant in terms of system capacity.

In FIG. 27, the probability mass functions (pmf) of precoding order of stations 1 and 2 are compared. By using GA-TH precoding, station 2 is more likely precoded first, compared to station 1. Therefore, in FIG. 28, the described method yields a significant SNR gain of 4 dB at BER of 10⁻² compared with the conventional technique.

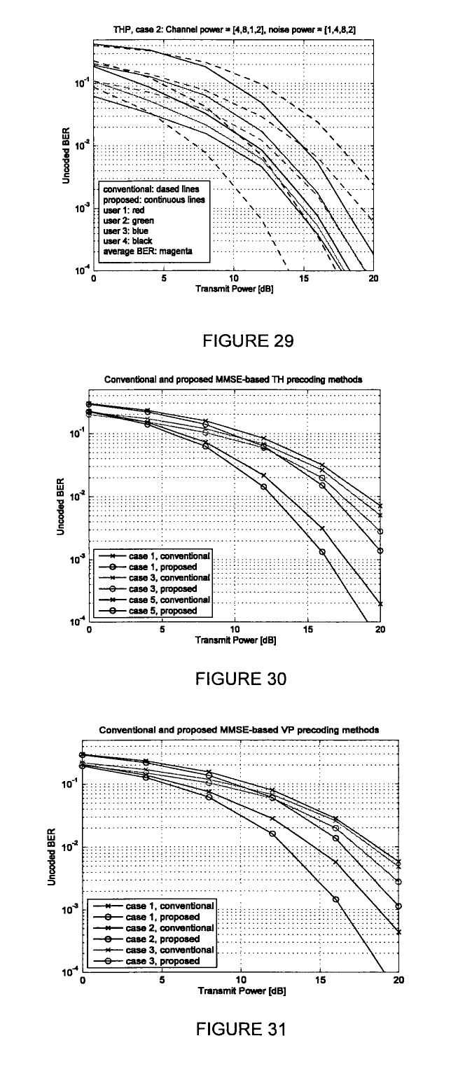

In FIG. 29 and FIG. 30, simulation results for four other test cases are presented, with parameters summarized below. In all simulations, significant SNR improvements are always obtainable. These results strongly support the described method.

| Test case | Channel power | Noise power |
|---|---|---|
| 1 | [1, 1, 1, 1] | [1, 2, 4, 8] |
| 2 | [4, 8, 1, 2] | [1, 4, 8, 2] |
| 3 | [32, 16, 4, 1] | [1, 4, 16, 32] |
| 4 | [1, 4, 1, 1] | [1, 8, 1, 1] |
| 5 | [1, 1, 1, 1] | [1, 2, 1.5, 0.5] |

The proposed method can be applied to vector perturbation precoding. In FIG. 31, simulation results show that significant SNR gain can be achieved for VP precoding.

The reader will appreciate that the foregoing are but examples of implementation of the present invention, and that further aspects, features, variations and advantages may arise from using the invention in different embodiments. The scope of protection is intended to be provided by the claims appended hereto, which are to be interpreted in the light of the description with reference to the drawings and not to be limited thereby. Each feature disclosed in the description and (where appropriate) the claims and drawings may be provided independently or in any appropriate combination.

1. A method of processing data prior to transmission thereof to a plurality of stations in a wireless communications system, the method comprising:
determining a channel matrix using a plurality of weighted channel responses, each of which is associated with one of the plurality of stations and weighted by a gain factor corresponding to said station, wherein said gain factor is inversely proportional to a noise power of said station; and
processing the data in accordance with a precoding scheme using said channel matrix.

2. A method in accordance with claim 1 comprising: receiving feedback information from each of said plurality of stations, wherein said feedback information comprises the weighted channel response.

3. A method in accordance with claim 1 comprising:
receiving feedback information from each of said stations, wherein said feedback information comprises a channel response and said noise power;
calculating said gain factor for each of said noise powers; and
weighting each channel response with the corresponding gain factor.

4. A method in accordance with claim 1 wherein said gain factor is defined using the relation gₖ=aₖvₖ⁻¹, wherein vₖ is the noise power and aₖ is a positive real number.

5. A method in accordance with claim 1 wherein said precoding scheme comprises a minimum mean square error (MMSE) Tomlinson-Harashima precoding scheme.

6. A method in accordance with claim 5 comprising determining a matrix Φ using the relation
$$Φ = \hat{H} {\hat{H}}^{H} + \frac{K}{{E}_{tr} } I ,$$
wherein Ĥ is a channel matrix determined by said determining, I is an identity matrix, K is the number of stations whose data is to be processed, and Eₜᵣ, is the total transmit power.

7. A method of transparently providing a station with a data recovery functionality, the data being subjected to a precoding scheme prior to transmission to the station, the method comprising: transmitting a scalar to the station, said scalar comprising a combination of a power normalization factor and a gain factor, wherein said gain factor is inversely proportional to a noise power of said station.

8. A multiple antenna apparatus for transmitting data to a plurality of stations, the apparatus comprising:
means for determining a channel matrix using a plurality of weighted channel responses, each of which is associated with one of a plurality of stations and weighted by a gain factor corresponding to said station; and
means for processing the data in accordance with a precoding scheme using said channel matrix.

9. A multiple antenna apparatus in accordance with claim 8 comprising:
means for calculating said gain factor for each of said noise powers; and
means for weighting each channel response with the corresponding gain factor.

10. A multiple antenna apparatus according to claim 8 comprising:
means for calculating scalars, each comprising a combination of a power normalization factor and a gain factor corresponding one of said plurality of stations.

11. A method of feeding back information to a multiple antenna apparatus from a station in a wireless communications system, the method comprising:
measuring a channel response and a noise power;
calculating a gain factor for said noise power, said gain factor being inversely proportional to said noise power;
weighting said channel response with said gain factor; and
transmitting the weighted channel response to said multiple antenna apparatus.

12. A method of recovering received data at a station, the received data having been subjected to a precoding scheme prior to transmission, the precoding scheme using a channel matrix comprising a weighted channel response associated with the station, the weighted channel response being weighted by a gain factor that is inversely proportional to a noise power of the station, the method comprising: applying said gain factor to the received data.

13. A method in accordance with claim 12 comprising applying a scalar comprised of a combination of a power normalization factor and said gain factor.

14. A station for receiving data from a multiple antenna apparatus, the station comprising:
means for measuring a noise power;
means for measuring a channel response;
means for calculating a gain factor for said noise power, said gain factor being inversely proportional to said noise power;
means for weighting said channel response with said gain factor; and
means for applying said gain factor to the received data.

15. A method of communicating between a multiple antenna apparatus and a plurality of stations, the method comprising:
feeding back information from the plurality of stations to the multiple antenna apparatus in accordance with claim 11;
processing data to be transmitted from said multiple antenna apparatus to said plurality of stations in accordance with claim 1;
receiving said data at said plurality of stations; and
recovering said data in accordance with claim 12.

16. A wireless communication system comprising:
a multiple antenna apparatus in accordance with claim 7; and
a plurality of stations in accordance with claim 14.

17. A storage medium storing computer executable instructions which, when executed on general purpose computer controlled communications apparatus, cause the apparatus to become configured to perform the method of claim 1.
